(19) United States
(12) Patent Application Publication
(10) Pub. No.: US 2026/0149811 A1
(43) Pub. Date: May 28, 2026

(54) Encoding Method, Decoding Method, Bitstream, Encoder, Decoder, and Storage Medium

(71) Applicant: GUANGDONG OPPO MOBILE TELECOMMUNICATIONS CORP., LTD., Dongguan (CN)

(72) Inventors: Shuai LI, Dongguan (CN); Yanbo GAO, Dongguan (CN); Hui YUAN, Dongguan (CN); Ming LI, Dongguan (CN); Dan ZOU, Dongguan (CN)

(73) Assignee: GUANGDONG OPPO MOBILE TELECOMMUNICATIONS CORP., LTD., Dongguan (CN)

(21) Appl. No.: 19/330,796

(22) Filed: Sep. 16, 2025

Related U.S. Application Data
(63) Continuation of application No. PCT/CN2023/082173, filed on Mar. 17, 2023.

(51) Int. Cl. H04N 19/137; G06T 5/50; G06V 10/77; H04N 19/172

(52) U.S. Cl. CPC H04N 19/137; G06T 5/50; G06V 10/7715; H04N 19/172

(57) ABSTRACT

Disclosed in embodiments of the present application are an encoding method, a decoding method, a code stream, an encoder, a decoder, and a storage medium. The decoding method is applied to the decoder, and comprises: decoding a bitstream, to determine a reconstruction motion parameter of a current image; determining an initial prediction image feature of the current image according to the reconstruction motion parameter; and performing enhancement processing on the initial prediction image feature according to at least one reference image, to determine a target prediction image feature of the current image, wherein the target prediction image feature is used for determining a reconstructed image of the current image.

### CROSS-REFERENCE TO RELATED APPLICATIONS

This application is a continuation of International Application No. PCT/CN2023/082173, filed on Mar. 17, 2023, the disclosure of which is hereby incorporated by reference in its entirety.

### TECHNICAL FIELD

Embodiments of this application relate to the field of video encoding and decoding technologies, and in particular, to an encoding method, a decoding method, a bitstream, an encoder, a decoder, and a storage medium.

### BACKGROUND

In video coding based on deep learning, currently there are mainly two types of technical solutions, that is, a feature-space video coding network (Feature-space Video Coding network, FVC) solution and a deep contextual video compression (Deep Contextual Video Compression, DCVC) solution.

The FVC solution is used as an example. In a motion estimation process, deformable convolution may be used to generate a motion vector representation, that is, an offset. However, because compression for the offset is a lossy process, a reconstructed motion vector representation (offset) is distorted. In addition, motion estimation based on a single reference image cannot predict a current image well, thereby reducing video encoding and decoding efficiency.

### SUMMARY

Embodiments of this application provide an encoding method, a decoding method, a bitstream, an encoder, a decoder, and a storage medium, which may improve quality of a predicted image, thereby improving encoding and decoding efficiency.

The technical solutions in embodiments of this application may be implemented as follows:

According to a first aspect, an embodiment of this application provides a decoding method, applied to a decoder, where the method includes:
decoding a bitstream, to determine a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, where the target predicted image feature is used to determine a reconstructed image of the current image.

According to a second aspect, an embodiment of this application provides an encoding method, applied to an encoder, where the method includes:
determining a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, where the target predicted image feature is used to determine a residual image feature of the current image.

According to a third aspect, an embodiment of this application provides a bitstream, where the bitstream is generated by performing bit encoding according to to-be-encoded information, where the to-be-encoded information includes at least one of the following:
a first motion parameter of a current image, a residual image feature of a current image, or a value of first identification information of a current image, where the first identification information is used to indicate whether a predicted image feature enhancement mode is used for the current image.

According to a fourth aspect, an embodiment of this application provides an encoder, where the encoder includes a first determining unit and a first enhancement unit, where
the first determining unit is configured to: determine a reconstructed motion parameter of a current image; and determine an initial predicted image feature of the current image based on the reconstructed motion parameter; and
the first enhancement unit is configured to: perform enhancement processing on the initial predicted image feature according to at least one reference image, to determine a target predicted image feature of the current image, where the target predicted image feature is used to determine a residual image feature of the current image.

According to a fifth aspect, an embodiment of this application provides an encoder, where the encoder includes a first memory and a first processor, where
the first memory is configured to store a computer program runnable on the first processor; and
the first processor is configured to execute the method according to the second aspect when running the computer program.

According to a sixth aspect, an embodiment of this application provides a decoder, where the decoder includes a decoding unit, a second determining unit, and a second enhancement unit, where
the decoding unit is configured to decode a bitstream, to determine a reconstructed motion parameter of a current image;
the second determining unit is configured to determine an initial predicted image feature of the current image based on the reconstructed motion parameter; and
the second enhancement unit is configured to: perform enhancement processing on the initial predicted image feature according to at least one reference image, to determine a target predicted image feature of the current image, where the target predicted image feature is used to determine a reconstructed image of the current image.

According to a seventh aspect, an embodiment of this application provides a decoder, where the decoder includes a second memory and a second processor, where
the second memory is configured to store a computer program runnable on the second processor; and
the second processor is configured to execute the method according to the first aspect when running the computer program.

According to an eighth aspect, an embodiment of this application provides a computer-readable storage medium, where the computer-readable storage medium stores a computer program, and when the computer program is executed, the method according to the first aspect or the method according to the second aspect is implemented.

Embodiments of this application provide an encoding method, a decoding method, a bitstream, an encoder, a decoder, and a storage medium. At both an encoding end and a decoding end, after a reconstructed motion parameter of a current image is determined, an initial predicted image feature of the current image is determined based on the reconstructed motion parameter. Then, enhancement processing is performed on the initial predicted image feature according to at least one reference image, to determine a target predicted image feature of the current image. At the encoding end, the target predicted image feature is used to determine a residual image feature of the current image. Then, the residual image feature is transmitted to the decoding end by using a bitstream, so that the decoding end can determine a reconstructed image of the current image based on the residual image feature and the target predicted image feature.

### BRIEF DESCRIPTION OF DRAWINGS

FIG. 1 is a schematic structural diagram of an FVC encoding framework.

FIG. 2 is a schematic structural diagram of an FVC decoding framework.

FIG. 3 is a schematic flowchart of a decoding method according to an embodiment of this application.

FIG. 4 is a schematic structural diagram of a prediction enhancement module according to an embodiment of this application.

FIG. 5 is a schematic diagram of a specific structure of a prediction enhancement module according to an embodiment of this application.

FIG. 6 is a schematic structural diagram of a feature extraction module according to an embodiment of this application.

FIG. 7 is a schematic structural diagram of a residual module according to an embodiment of this application.

FIG. 8 is a schematic structural diagram of a predicted feature generation module according to an embodiment of this application.

FIG. 9 is a schematic diagram of a detailed structure of a predicted feature generation module according to an embodiment of this application.

FIG. 10 is a schematic flowchart of another decoding method according to an embodiment of this application.

FIG. 11 is a schematic structural diagram of a reconstruction and enhancement module according to an embodiment of this application.

FIG. 12 is a schematic flowchart of an encoding method according to an embodiment of this application.

FIG. 13 is a schematic structural diagram of a motion parameter generation module according to an embodiment of this application.

FIG. 14 is a schematic diagram of a detailed structure of a motion parameter generation module according to an embodiment of this application.

FIG. 15 is a schematic structural diagram of an encoding module of an autoencoder according to an embodiment of this application.

FIG. 16 is a schematic structural diagram of a decoding module of an autoencoder according to an embodiment of this application.

FIG. 17 is a schematic diagram of a network architecture of video encoding and decoding according to an embodiment of this application.

FIG. 18 is a schematic diagram of a detailed framework of an encoder according to an embodiment of this application.

FIG. 19 is a schematic diagram of a specific structure of another prediction enhancement module according to an embodiment of this application.

FIG. 20 is a schematic diagram of a detailed framework of a decoder according to an embodiment of this application.

FIG. 21 is a schematic structural diagram of an encoder according to an embodiment of this application.

FIG. 22 is a schematic diagram of a specific hardware structure of an encoder according to an embodiment of this application.

FIG. 23 is a schematic structural diagram of a decoder according to an embodiment of this application.

FIG. 24 is a schematic diagram of a specific hardware structure of a decoder according to an embodiment of this application.

FIG. 25 is a schematic structural diagram of an encoding and decoding system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

In video coding based on deep learning, currently there are mainly two types of technical solutions, that is, a feature-space video coding network (Feature-space Video Coding network, FVC) solution and a deep contextual video compression (Deep Contextual Video Compression, DCVC) solution. A motion estimation manner of the FVC solution is different from that of the DCVC solution, where the former is a motion estimation manner based on deformable convolution, and the latter is a motion estimation manner based on an optical stream. However, they have basically the same general encoding process. Embodiments of this application mainly provide an encoding method and a decoding method that are based on the FVC solution.

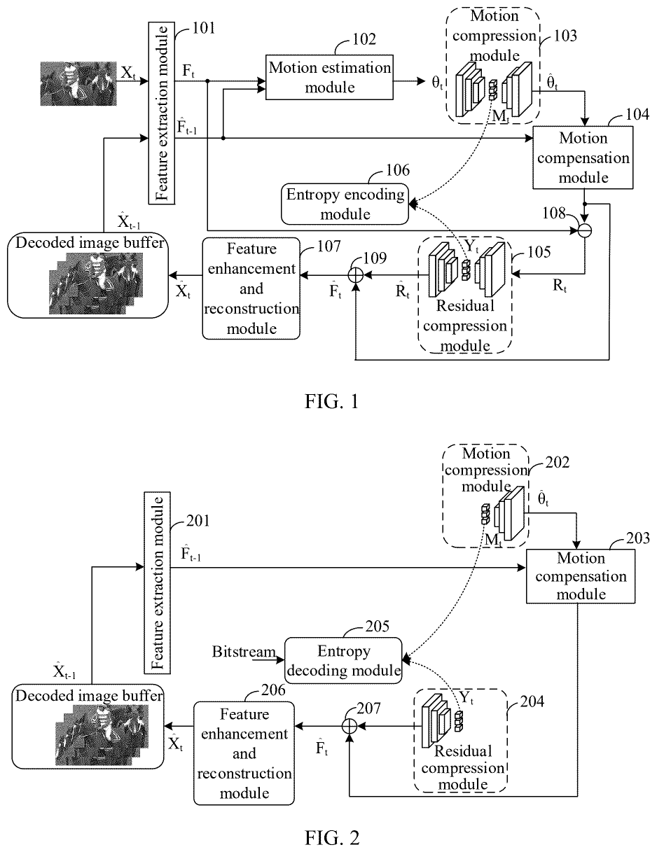

FIG. 1 is a schematic structural diagram of an FVC encoding framework. As shown in FIG. 1, the FVC encoding framework mainly includes a feature extraction module 101, a motion estimation module 102, a motion compression module 103, a motion compensation module 104, a residual compression module 105, an entropy encoding module 106, a feature enhancement and reconstruction module 107, a subtractor 108, and an adder 109. First, feature extraction is performed on a current image (a to-be-encoded image) and a reconstructed image (an encoded image, which is used for reference) by using the feature extraction module 101, to obtain Fₜ and \hat{F}ₜ₋₁. Then, Fₜ and \hat{F}ₜ₋₁ are processed by the motion estimation module 102, to obtain a motion parameter θₜ. In the motion compression module 103, the motion parameter θₜ is encoded by using an encoding module of an autoencoder and the entropy encoding module 106, to generate a bitstream Mₜ. The bitstream is transmitted to a decoding end, and decoding and reconstruction is performed on Mₜ by using a decoding module of the autoencoder, to obtain \hat{θ}ₜ, which is used by the motion compensation module 104. Herein, a motion compensation process is as follows. A reconstructed image (reference image) feature is transformed by using the motion parameter \hat{θ}ₜ, to generate a predicted image feature. Then, a subtraction operation is performed on a current image feature and the predicted image feature by using the subtractor 108, to obtain a residual image feature Rₜ. In the residual compression module 105, the residual image feature Rₜ is further processed by using the encoding module of the autoencoder and the entropy encoding module 106, to generate a bitstream Yₜ. The bitstream is transmitted to the decoding end, and decoding and reconstruction is performed on Yₜ by using the decoding module of the autoencoder, to obtain a reconstructed residual Rₜ. Then, the reconstructed residual and the predicted image feature are added by using the adder 109, to generate \hat{F}ₜ, and a final reconstructed image \hat{X}ₜ is generated by using the feature enhancement and reconstruction module 107. The reconstructed image \hat{X}ₜ may be stored in a decoded image buffer for reference of a subsequent image.

Specifically, for the motion estimation module of the FVC solution shown in FIG. 1, a motion vector representation, that is, an offset (offset), may be generated through deformable convolution, and then the offset is encoded based on the encoding module of the autoencoder and the entropy encoding module, to generate a bitstream (also referred to as a “bit stream”). The bitstream is processed by entropy decoding, and then is processed by the decoding module of the autoencoder, to generate a reconstruction offset. Deformable convolution is performed on the reconstruction offset by using a reference image feature, to generate the predicted image feature (that is, motion compensation). Then, a subtraction operation is performed on the predicted image feature and the current image feature, to generate the residual image feature. Subsequently, quantization and encoding are performed.

FIG. 2 is a schematic structural diagram of an FVC decoding framework. As shown in FIG. 2, the FVC encoding framework mainly includes a feature extraction module 201, a motion compression module 202, a motion compensation module 203, a residual compression module 204, an entropy decoding module 205, a feature enhancement and reconstruction module 206, and an adder 207. First, feature extraction is performed on a reconstructed image (a decoded image, which is used for reference) by using the feature extraction module 201, to obtain \hat{F}ₜ₋₁. In addition, in the motion compression module 202, decoding and reconstruction is performed on Mₜ by using the entropy decoding module 205 and a decoding module of an autoencoder, to obtain a motion parameter \hat{θ}ₜ. Herein, the motion parameter \hat{θ}ₜ may be used by the motion compensation module 203. A motion compensation process is as follows. A reconstructed image (reference image) feature is transformed by using \hat{θ}ₜ, to generate a predicted image feature. In the residual compression module 204, decoding and reconstruction is performed on Yₜ by using the entropy decoding module 205 and the decoding module of the autoencoder, to obtain a reconstructed residual \hat{R}ₜ. Finally, the reconstructed residual and the predicted image feature are added by using the adder 207, to generate \hat{F}ₜ, and a final reconstructed image \hat{X}ₜ is generated by using the feature enhancement and reconstruction module 206. The reconstructed image \hat{X}ₜ may be stored in a decoded image buffer for reference of a subsequent image.

Briefly, in the foregoing process of generating the reference image through motion estimation and motion compensation, compression of a motion vector representation (offset) is a lossy process, and therefore, a reconstructed motion vector representation (offset) is distorted. Second, a high-quality reference image cannot be generated through motion estimation based on a single reference image. That is, compared with prediction based on a plurality of reference images, a current image cannot be effectively predicted based on only one reference image, thereby reducing video encoding and decoding efficiency.

Based on this, an embodiment of this application provides an encoding method. First, a reconstructed motion parameter of a current image is determined. Then, an initial predicted image feature of the current image is determined based on the reconstructed motion parameter. Then, enhancement processing is performed on the initial predicted image feature according to at least one reference image, to determine a target predicted image feature of the current image, where the target predicted image feature is used to determine a residual image feature of the current image.

An embodiment of this application further provides a decoding method. First, a bitstream is decoded, to determine a reconstructed motion parameter of a current image. Then, an initial predicted image feature of the current image is determined based on the reconstructed motion parameter. Then, enhancement processing is performed on the initial predicted image feature according to at least one reference image, to determine a target predicted image feature of the current image, where the target predicted image feature is used to determine a reconstructed image of the current image.

In this way, after the initial predicted image feature of the current image is determined based on the reconstructed motion parameter, enhancement processing may be performed on the initial predicted image feature by using a reconstructed reference image, thereby improving quality of a predicted image and reducing distortion of the predicted image. In addition, for a reason such as an occluded region caused by motion, a predicted image cannot be well generated by using a single reference image. In this case, enhancement processing is performed on the initial predicted image feature by using at least one reconstructed reference image, which can further improve quality of the predicted image, thereby improving quality of the reconstructed image of the current image and improving encoding and decoding efficiency.

The following describes embodiments of this application in detail with reference to the accompanying drawings.

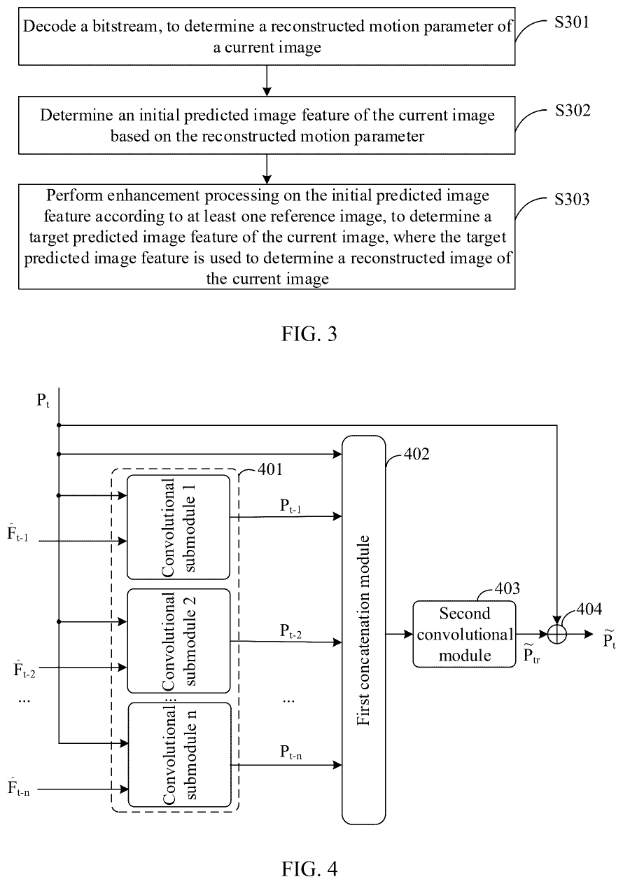

In an embodiment of this application, referring to FIG. 3, FIG. 3 is a schematic flowchart of a decoding method according to embodiments of this application. As shown in FIG. 3, the method may include the following steps.

S301: Decode a bitstream, to determine a reconstructed motion parameter of a current image.

It should be noted that the decoding method in embodiments of this application is applied to a decoder. In addition, the decoding method may specifically refer to a method for generating a predicted image enhanced based on multiple images. In addition, the method is embedded in a video encoding loop. Both an encoding end and a decoding end may enhance a predicted image feature generated in a conventional manner of motion compensation by using a plurality of reconstructed reference images, thereby improving quality of a predicted image.

It should be further noted that, in embodiments of this application, the reconstructed motion parameter of the current image may be denoted as et. Because the reconstructed motion parameter \hat{θ}ₜ has been written into the bitstream, at the decoding end, the reconstructed motion parameter \hat{θ}ₜ of the current image can be obtained by decoding the bitstream.

It may be understood that the decoder includes at least an entropy decoder and a decoding module of an autoencoder. In some embodiments, the decoding the bitstream, to determine the reconstructed motion parameter of the current image may include:
decoding the bitstream by using the entropy decoder, to determine a first decoding feature; and
performing decoding processing on the first decoding feature by using the decoding module of the autoencoder, to determine the reconstructed motion parameter of the current image.

In embodiments of this application, the first decoding feature may be denoted as Mₜ. First, entropy decoding is performed on a motion reference bitstream, to acquire the first decoding feature Mₜ corresponding to the motion reference bitstream. Then, the reconstructed motion parameter \hat{θ}ₜ may be acquired by using the decoding part of the autoencoder. Exemplarily, a decoding process is as follows:

$${\hat{θ}}_{t} = {f}_{d e c o d e r} ( {M}_{t} ) \qquad ( 1 )$$

Herein, f_{decoder}(*) denotes a decoding module of a motion parameter autoencoder, which implements decoding processing on the first decoding feature Mₜ.

S302: Determine an initial predicted image feature of the current image based on the reconstructed motion parameter.

S303: Perform enhancement processing on the initial predicted image feature according to at least one reference image, to determine a target predicted image feature of the current image, where the target predicted image feature is used to determine a reconstructed image of the current image.

It should be noted that, in embodiments of this application, after being obtained, the reconstructed motion parameter may be used to determine the initial predicted image feature of the current image. Then, the enhancement processing is performed on the initial predicted image feature according to the at least one reference image, to obtain a high-quality reconstructed image.

In some embodiments, the performing the enhancement processing on the initial predicted image feature according to the at least one reference image, to determine the target predicted image feature of the current image may include:
separately performing feature extraction on the at least one reference image, to determine at least one reference image feature; and
performing the enhancement processing on the initial predicted image feature according to the at least one reference image feature, to determine the target predicted image feature.

It should be further noted that in embodiments of this application, the at least one reference image is a reconstructed image, and the reference image may be a reconstructed image of an image preceding to the current image by m frames, where m is an integer greater than or equal to 1.

It should be further noted that, in embodiments of this application, each reference image is used to extract a respective reference image feature, and then the enhancement processing is performed on the initial predicted image feature by using the reference image feature. The enhancement processing may be implemented by a prediction enhancement module. In some embodiments, the performing the enhancement processing on the initial predicted image feature according to the at least one reference image feature, to determine the target predicted image feature may include: performing an enhancement operation on the at least one reference image feature and the initial predicted image feature by using the prediction enhancement module, to determine the target predicted image feature.

It may be understood that, in embodiments of this application, the prediction enhancement module may be a network structure for generating a target predicted image feature by enhancement based on a plurality of reference images. The prediction enhancement module includes a first convolutional module, a first concatenation module, a second convolutional module, and a first addition module. Correspondingly, in some embodiments, the performing the enhancement operation on the at least one reference image feature and the initial predicted image feature by using the prediction enhancement module, to determine the target predicted image feature may include:
separately using the at least one reference image feature to perform a convolution operation with the initial predicted image feature by using the first convolutional module, to obtain at least one correction feature;
performing a concatenation operation on the at least one correction feature and the initial predicted image feature by using the first concatenation module, to obtain a concatenated feature;
performing convolutional fusion processing on the concatenated feature by using the second convolutional module, to obtain a fused correction feature; and
performing an addition operation on the fused correction feature and the initial predicted image feature by using the first addition module, to obtain the target predicted image feature.

It should be noted that in embodiments of this application, the first convolutional module may include at least one convolutional submodule, and a quantity of the at least one convolutional submodule has a correspondence with a quantity of the at least one reference image.

That is, in embodiments of this application, each convolutional submodule may perform a convolution operation on the reference image feature and the initial predicted image feature, to obtain a corresponding correction feature. Then, the first concatenation module performs a concatenation operation on the correction features and the initial predicted image feature, and the second convolutional module performs convolutional fusion on a concatenated feature, to obtain a fused correction feature. Finally, the first addition module performs summation calculation on the fused correction feature and the initial predicted image feature, to obtain the target predicted image feature.

Exemplarily, FIG. 4 is a schematic structural diagram of a prediction enhancement module according to an embodiment of this application. As shown in FIG. 4, the prediction enhancement module may include a first convolutional module 401, a first concatenation module 402, a second convolutional module 403, and a first addition module 404. The first convolutional module 401 includes a convolutional submodule 1, a convolutional submodule 2, . . . , and a convolutional submodule n, where n is an integer greater than or equal to 1.

In FIG. 4, an initial predicted image feature may be denoted as Pₜ, a first reference image feature may be denoted as \hat{F}ₜ₋₁, a second reference image feature may be denoted as \hat{F}ₜ₋₂, and an n reference image feature may be denoted as \hat{F}ₜ₋ₙ. Specifically, the convolutional submodule 1 is configured to perform a convolution operation on \hat{F}ₜ₋₁ and Pₜ, to generate a first correction feature, which is denoted as Pₜ₋₁. The convolutional submodule 2 is configured to perform a convolution operation on \hat{F}ₜ₋₂ and Pₜ, to generate a second correction feature, which is denoted as Pₜ₋₂. The convolutional submodule n is configured to perform a convolution operation on \hat{F}ₜ₋ₙ and Pₜ, to generate an n-th correction feature, which is denoted as Pₜ₋ₙ. Then, the first concatenation module 402 performs a concatenation operation on Pₜ, Pₜ₋₁, Pₜ₋₂, . . . , and Pₜ₋ₙ, and the second convolutional module 403 performs convolutional fusion, to generate a fused correction feature, which is denoted as \tilde{P}ₜᵣ. Finally, the first addition module 404 performs an addition operation on Pₜ and \tilde{P}ₜᵣ by using a residual structure, to obtain a final target predicted image feature, which is denoted as \tilde{P}ₜ.

In a specific implementation, a convolutional submodule may include a first convolutional layer and a first deformable convolutional layer, the first concatenation module may include a first concatenation layer, and the second convolutional module may include a second convolutional layer.

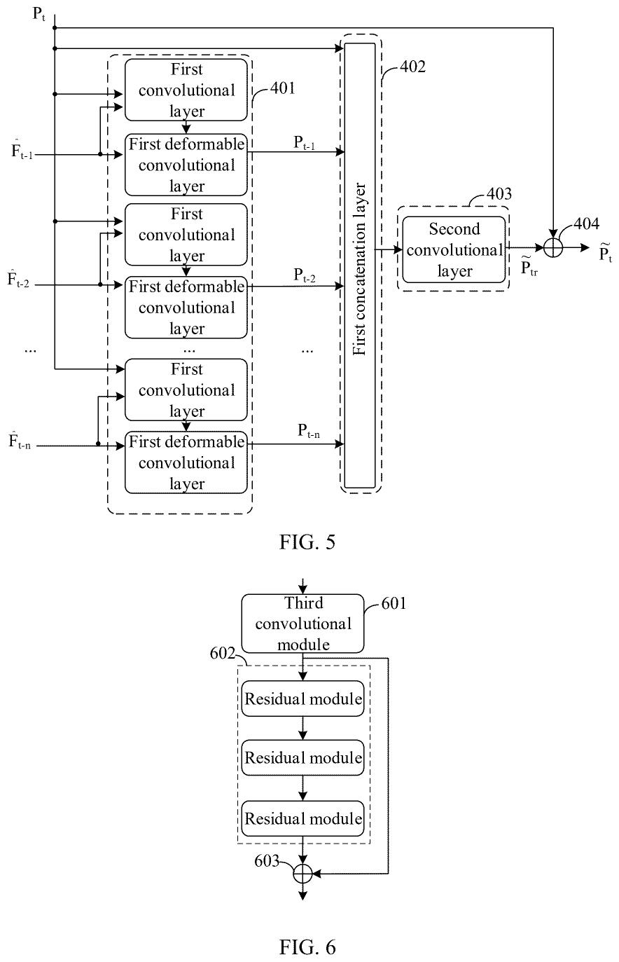

Exemplarily, FIG. 5 is a schematic diagram of a specific structure of a prediction enhancement module according to an embodiment of this application. As shown in FIG. 5, in the first convolutional module 401, each convolutional submodule includes a first convolutional layer and a first deformable convolutional layer, the first concatenation module 402 may include a first concatenation layer, and the second convolutional module 403 includes a second convolutional layer. The first deformable convolutional layer may be denoted as Deformable Conv, and the first concatenation layer may be denoted as Cat. A convolution parameter of the first convolutional layer and that of the second convolutional layer may be the same or different. For example, a quantity of channels of the first convolutional layer is set to 64, a size of a convolutional kernel is 3×3, and a step is set to 1, that is, the first convolutional layer may be denoted as Conv(64,3,1). A quantity of channels of the second convolutional layer is set to 64, a size of a convolutional kernel is 1×1, and a step is set to 1, that is, the second convolutional layer may be denoted as Conv(64,1,1).

In embodiments of this application, for a convolutional submodule, a concatenation operation may be performed on an initial predicted image feature and a reference image feature, and then an offset between the reference image feature and the initial predicted image feature may be generated by using the first convolutional layer and a corresponding activation function. A specific process is as follows:

$${o}_{t - n} = c o n v ( r e l u ( c o n v ( c a t ( {\hat{F}}_{t - n} , {P}_{t} ) ) ) ) \qquad ( 2 )$$

After the offset is acquired, a deformable convolution operation may be performed by using the first deformable convolutional layer, to generate a corresponding correction feature from a reconstructed image at a past instant. A specific process is as follows:

$${P}_{t - n} = D c o n v ( {\hat{F}}_{t - n} , {o}_{t - n} ) \qquad ( 3 )$$

A concatenation operation is performed on at least one generated correction feature and the initial predicted image feature, and convolutional fusion processing is performed by using the second convolutional layer, to finally generate a fused correction feature. A specific process is as follows:

$${\tilde{P}}_{tr} = c o n v ( c a t ( {P}_{t} , {P}_{t - 1} , {P}_{t - 2} , … , {P}_{t - n} ) \qquad ( 4 )$$

Finally, an addition operation is performed on the fused correction feature and the initial predicted image feature by using a residual structure, to generate a final target predicted image feature. A specific process is as follows:

$${\tilde{P}}_{t} = {\tilde{P}}_{tr} + {P}_{t} \qquad ( 5 )$$

In another specific implementation, the convolutional submodule may include a first convolutional layer, the first concatenation module may include a first concatenation layer, and the second convolutional module may include a second convolutional layer.

That is, in embodiments of this application, for each convolutional submodule, a process of using the reference image feature to correct the current predicted image by a deformable convolutional layer may be directly implemented through convolution, that is, the first deformable convolutional layer may be omitted herein. In this case, the initial predicted image feature is directly fused with a reference image feature at a past instant, and then a final target predicted image feature is generated through convolution.

It should be noted that, a specific internal structure of the first convolutional module, the first concatenation module, or the second convolutional module is not limited in embodiments of this application. For example, there may be at least one first convolutional layer, and there may also be at least one second convolutional layer. Convolution parameters (such as a size of a convolutional kernel and a quantity of channels) of these convolutional layers may be the same or different. This is not limited herein.

It should be further noted that, in embodiments of this application, the final target predicted image feature may be directly generated without using the residual structure. Specifically, in generating the target predicted image feature, the residual structure may be used, that is, an addition operation may be performed on the initial predicted image feature and the fused correction feature that is enhanced by using at least one reference image. However, the addition operation may alternatively not be used herein, and the initial predicted image feature and the fused correction feature are directly concatenated, to generate the final target predicted image feature. That is, the first addition module may not be required herein, which is not limited.

It may be further understood that in embodiments of this application, the enhancement processing is performed according to the at least one reference image feature herein. Therefore, first, a reference image feature corresponding to each reference image needs to be extracted. In some embodiments, the separately performing the feature extraction on the at least one reference image, to determine the at least one reference image feature may include: separately performing the feature extraction on the at least one reference image by using a feature extraction module, to determine the at least one reference image feature.

That is, the feature extraction may be implemented by the feature extraction module. A same feature extraction module may be used for the at least one reference image. Exemplarily, there are three reference images, for example, a first reference image, a second reference image, and a third reference image. In some embodiments, the separately performing the feature extraction on the at least one reference image by using the feature extraction module, to determine the at least one reference image feature may include:
performing the feature extraction on the first reference image by using the feature extraction module, to obtain a first reference image feature;
performing the feature extraction on the second reference image by using the feature extraction module, to obtain a second reference image feature;
performing the feature extraction on the third reference image by using the feature extraction module, to obtain a third reference image feature; and
determining the first reference image feature, the second reference image feature, and the third reference image feature as the at least one reference image feature.

It should be noted that in embodiments of this application, if three reference images are used to perform the enhancement processing on the initial predicted image feature, specifically, the first reference image feature, the second reference image feature, and the third reference image feature may be used to perform the enhancement processing on the initial predicted image feature, to generate the target predicted image feature.

In a specific embodiment, the first reference image is a reconstructed image of an image preceding to the current image by one frame, the second reference image is a reconstructed image of an image preceding to the current image by two frames, and the third reference image is a reconstructed image of an image preceding to the current image by three frames.

In embodiments of this application, the first reference image may be denoted as \hat{X}ₜ₋₁, and the first reference image feature may be denoted as \hat{F}ₜ₋₁. The second reference image may be denoted as \hat{X}ₜ₋₂, and the second reference image feature may be denoted as \hat{F}ₜ₋₂. The third reference image may be denoted as \hat{X}ₜ₋₃, and the third reference image feature may be denoted as \hat{F}ₜ₋₃. Specifically, a feature extraction process is as follows:

$${\hat{F}}_{t - 1} = {f}_{feat} ( {\hat{X}}_{t - 1} ) ; {\hat{F}}_{t - 2} = {f}_{feat} ( {\hat{X}}_{t - 2} ) ; {\hat{F}}_{t - 3} = {f}_{feat} ( {\hat{X}}_{t - 3} ) \qquad ( 6 )$$

Herein, f_{feat}(*) denotes the feature extraction module, which is configured to separately perform the feature extraction on the at least one reference image.

It should be further noted that, in embodiments of this application, a quantity of reference image features may be 1, 2, 3, or even more. Herein, that three reference images are used to extract corresponding reference image features is merely used as an example. However, a specific quantity of reference images and a specific quantity of reference image features are not limited.

It may be understood that, in embodiments of this application, the feature extraction module is a network structure used to implement image feature extraction, and may also be referred to as a “feature extraction network”. The feature extraction module includes a third convolutional module, at least one residual module, and a second addition module. The feature extraction of the first reference image is used as an example. Correspondingly, in some embodiments, the performing the feature extraction on the first reference image by using the feature extraction module, to obtain the first reference image feature may include:
performing feature extraction on the first reference image by using the third convolutional module, to obtain a first intermediate feature;
performing feature extraction on the first intermediate feature by using the at least one residual module, to obtain a second intermediate feature; and
performing an addition operation on the first intermediate feature and the second intermediate feature by using the second addition module, to obtain the first reference image feature.

It should be noted that, in embodiments of this application, the third convolutional module may include a third convolutional layer. An internal structure of the third convolutional module and a specific quantity of third convolutional layers are not limited herein. In addition, for the feature extraction module, a quantity of residual modules may be 3, but may alternatively be another number. A specific quantity of residual modules is not limited herein.

Exemplarily, FIG. 6 is a schematic structural diagram of a feature extraction module according to an embodiment of this application. As shown in FIG. 6, the feature extraction module may include a third convolutional module 601, three residual modules 602, and a second addition module 603. The third convolutional module 601 may include a third convolutional layer, which is denoted as Conv(64,5,2). The residual modules may be denoted as Resblock(64,3). In this way, a first reference image is used as an example. First, the first reference image is input to the third convolutional module 601, to obtain a first intermediate feature. Then, the three residual modules 602 are successively used to perform feature extraction on the first intermediate feature, to obtain a second intermediate feature. Then, the second addition module 603 performs an addition operation on the first intermediate feature and the second intermediate feature, to obtain a first reference image feature.

Further, the residual module may be a convolutional block based on a residual structure, and belongs to a basic composition module. In some embodiments, the residual module may include at least one residual convolutional layer and at least one activation layer. The activation layer may be a non-linear activation function, and the activation function is used to add a non-linear factor, to resolve a problem that cannot be resolved by a linear model. This plays a very important role in learning and understanding a very complicated non-linear function by an artificial neural network model. Exemplarily, the activation function may be a Sigmoid function, a Tanh function, a rectified linear unit (The Rectified Linear Unit, ReLU) function, or the like. In embodiments of this application, the ReLU function may be used as the activation layer, but is not limited.

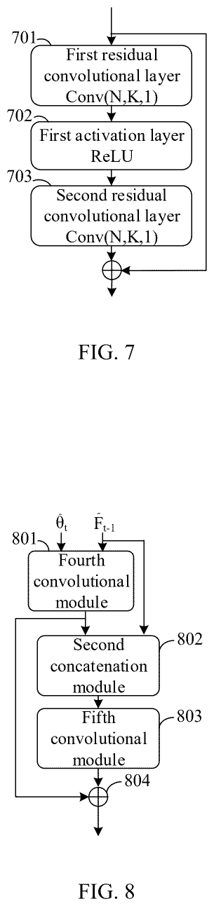

In addition, the residual module may include only one residual convolutional layer, or may include two or more residual convolutional layers. Exemplarily, FIG. 7 is a schematic structural diagram of a residual module according to an embodiment of this application. As shown in FIG. 7, the residual module may include a first residual convolutional layer 701, a first activation layer 702, and a second residual convolutional layer 703. Both the first residual convolutional layer and the second residual convolutional layer may be denoted as Conv(N,K,1), and the first activation layer may be denoted as ReLU.

Herein, convolution parameters (such as a size of a convolutional kernel and a quantity of channels) of the first residual convolutional layer 701 and the second residual convolutional layer 703 may be the same or different. Specifically, for the first residual convolutional layer 701 and the second residual convolutional layer 703, the quantity of channels may be set to N, and the size of the convolutional kernel may be K×K, where both N and K are positive integers. However, it should be noted that the size of the convolutional kernel and the quantity of channels of the first residual convolutional layer and those of the second residual convolutional layer are not fixed design, and may be adjusted herein. Specific values are not limited.

It may be further understood that, for the initial predicted image feature of the current image, in some embodiments, the determining the initial predicted image feature of the current image based on the reconstructed motion parameter may include:
determining a first reference image;
performing feature extraction on the first reference image, to determine a first reference image feature; and
performing motion compensation according to the first reference image feature and the reconstructed motion parameter, to determine the initial predicted image feature.

In embodiments of this application, the first reference image may be adjacent to the current image, and the first reference image is a reconstructed image of an image preceding to the current image by one frame. That is, if the current image is Xₜ, the first reference image may be \hat{X}ₜ₋₁, where t is a positive integer. In other words, the first reference image is the reconstructed image of the previous moment relative to the current image's time.

In embodiments of this application, the feature extraction of the first reference image may be implemented by a feature extraction module. In some embodiments, the performing the feature extraction on the first reference image, to determine the first reference image feature may include: performing the feature extraction on the first reference image by using the feature extraction module, to determine the first reference image feature. The feature extraction module may include a third convolutional module, at least one residual module, and a second addition module. For a specific structure of the feature extraction module, reference is made to FIG. 6.

In some embodiments, after the first reference image feature is obtained through extraction, the performing the motion compensation according to the first reference image feature and the reconstructed motion parameter, to determine the initial predicted image feature may include: performing the motion compensation on the first reference image feature and the reconstructed motion parameter by using a predicted feature generation module, to determine the initial predicted image feature.

It may be understood that, in embodiments of this application, the predicted feature generation module is a network structure used to implement generation of the initial predicted image feature, and may also be referred to as a “predicted image feature generation network”. The predicted feature generation module includes a fourth convolutional module, a second concatenation module, a fifth convolutional module, and a third addition module. Correspondingly, in some embodiments, the performing the motion compensation on the first reference image feature and the reconstructed motion parameter by using the predicted feature generation module, to determine the initial predicted image feature may include:
performing a deformable convolution operation on the reconstructed motion parameter and the first reference image feature by using the fourth convolutional module, to obtain a third intermediate feature;
performing a concatenation operation on the third intermediate feature and the first reference image feature by using the second concatenation module, to obtain a fourth intermediate feature;
performing a convolution operation on the fourth intermediate feature by using the fifth convolutional module, to obtain a fifth intermediate feature; and
performing an addition operation on the third intermediate feature and the fifth intermediate feature by using the third addition module, to obtain the initial predicted image feature.

It should be noted that, in embodiments of this application, the fourth convolutional module may include a second deformable convolutional layer, the second concatenation module may include a second concatenation layer, and the fifth convolutional module may include a fifth convolutional layer.

It should be further noted that, a specific internal structure of the fourth convolutional module, the second concatenation module, or the fifth convolutional module is not limited in embodiments of this application. For example, there may be at least one second deformable convolutional layer, and there may also be at least one fifth convolutional layer. Convolution parameters (such as a size of a convolutional kernel and a quantity of channels) of these convolutional layers may be the same or different. This is not limited herein.

Exemplarily, FIG. 8 is a schematic structural diagram of a predicted feature generation module according to an embodiment of this application. As shown in FIG. 8, the predicted feature generation module may include a fourth convolutional module 801, a second concatenation module 802, a fifth convolutional module 803, and a third addition module 804. First, a reconstructed motion parameter \hat{θ}ₜ and a first reference image feature \hat{F}ₜ₋₁ are input to the fourth convolutional module 801 for performing a deformable convolution operation, to obtain a third intermediate feature. Then, the second concatenation module 802 performs a concatenation operation on the third intermediate feature and the first reference image feature, and then the fifth convolutional module 803 performs a convolution operation, to obtain a fifth intermediate feature. Finally, the third addition module 804 performs an addition operation on the third intermediate feature and the fifth intermediate feature, to obtain an initial predicted image feature Pₜ of a current image.

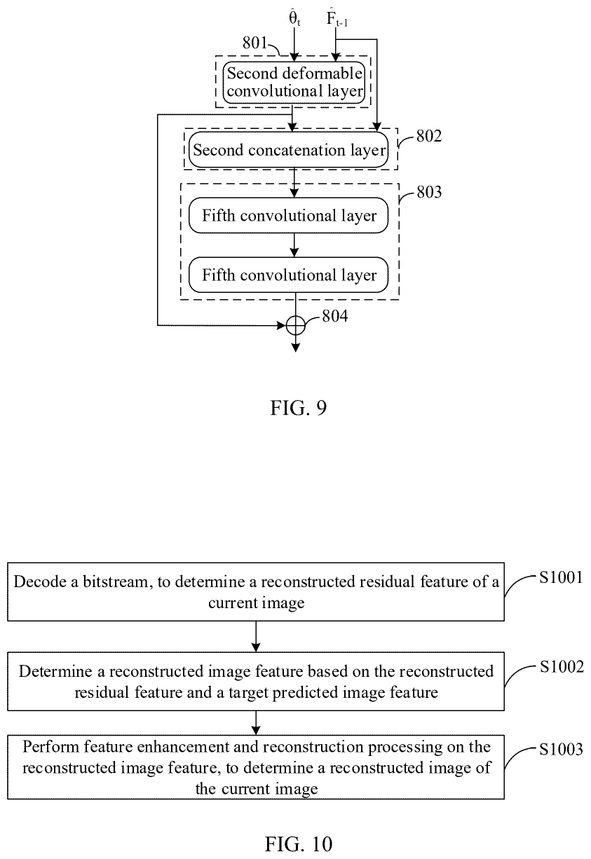

Exemplarily, FIG. 9 is a schematic diagram of a detailed structure of a predicted feature generation module according to an embodiment of this application. As shown in FIG. 9, the fourth convolutional module 801 may include a second deformable convolutional layer, the second concatenation module 802 may include a second concatenation layer, and the fifth convolutional module 803 may include two fifth convolutional layers. The second deformable convolutional layer may be denoted as Deformable Conv, the second concatenation layer may be denoted as Cat, and the fifth convolutional layers may be denoted as Conv(64,3,1). Specifically, a quantity of channels is set to 64, a size of a convolutional kernel may be 3×3, and a step is set to 1. However, it should be noted that convolution parameters (such as a size of a convolutional kernel and a quantity of channels) of the fifth convolutional layers are not fixed design, and may be adjusted herein. Specific values are not limited.

Herein, the second deformable convolutional layer is used to perform a convolution operation on a reconstructed motion parameter \hat{θ}ₜ and a first reference image feature \hat{F}ₜ₋₁, to finally generate an initial predicted image feature Pₜ (that is, motion compensation). A specific process is as follows:

$${P}_{t} = {f}_{e n {c}_{p r e}} ( D c o n v ( {\hat{F}}_{t - 1} , {\hat{θ}}_{t} ) ) \qquad ( 7 )$$

Herein, Dconv(*) is the second deformable convolutional layer of the fourth convolutional module 801, and f_{enc}_{ₚᵣₑ} is a two-layer convolutional network of the fifth convolutional module 803 for feature enhancement. Finally, the initial predicted image feature Pₜ can be generated.

It should be noted that, in embodiments of this application, for any of the feature extraction module, the prediction enhancement module, the predicted feature generation module, or the like, the structures provided herein are merely examples. A person skilled in the art may learn that the internal structures of these modules are not limited thereto.

In this way, in embodiments of this application, at least one reference image feature is respectively extracted according to at least one reference image, and the at least one reference image feature is separately concatenated with the initial predicted image feature generated through motion compensation, to generate an offset for deformable convolution. Then, the reference image feature is processed through deformable convolution, to generate a correction feature (which may also be referred to as a “compensation feature”) corresponding to the reference image feature. After concatenation and convolutional fusion processing are performed on the compensation feature and the initial predicted image feature, a fused correction feature may be obtained. Then, an addition operation is performed on the obtained fused correction feature and the initial predicted image feature, to generate a final target predicted image feature \tilde{P}ₜ, that is, the compensation feature is used to correct the current initial predicted image feature.

Further, after the target predicted image feature is obtained, a reconstructed image of a current image may be determined based on the target predicted image feature. In some embodiments, referring to FIG. 10, the method may include the following steps.

S1001: Decode the bitstream, to determine a reconstructed residual feature of the current image.

It should be noted that in embodiments of this application, the decoder includes at least an entropy decoder and a decoding module of an autoencoder. Correspondingly, in some embodiments, the decoding the bitstream, to determine the reconstructed residual feature of the current image may include:
decoding the bitstream by using the entropy decoder, to determine a second decoding feature; and
performing decoding processing on the second decoding feature by using the decoding module of the autoencoder, to determine the reconstructed residual feature of the current image.

In embodiments of this application, the second decoding feature may be denoted as Yₜ. First, entropy decoding is performed on a residual reference bitstream, to acquire the second decoding feature Yₜ corresponding to the residual reference bitstream. Then, the reconstructed residual feature \hat{R}ₜ may be acquired by using the decoding part of the autoencoder. Exemplarily, a decoding process is as follows:

$${\hat{R}}_{t} = {f}_{decoder\_R} ( {Y}_{t} ) \qquad ( 8 )$$

Herein, f_{decoder_R}(*) denotes a decoding module of a residual autoencoder, which implements decoding processing on the second decoding feature Yₜ.

S1002: Determine a reconstructed image feature based on the reconstructed residual feature and the target predicted image feature.

S1003: Perform feature enhancement and reconstruction processing on the reconstructed image feature, to determine the reconstructed image of the current image.

It should be noted that, in embodiments of this application, the reconstructed image feature can be determined based on the obtained reconstructed residual feature and the obtained target predicted image feature. In some embodiments, the determining the reconstructed image feature may include: performing an addition operation on the reconstructed residual feature and the target predicted image feature, to obtain the reconstructed image feature.

In a specific embodiment, the determining the reconstructed image feature based on the reconstructed residual feature and the target predicted image feature may include: performing an addition operation on the reconstructed residual feature and the target predicted image feature by using a fourth addition module, to obtain the reconstructed image feature. Herein, the reconstructed residual feature and the target predicted image feature are added by using the fourth addition module, to generate the reconstructed image feature. For a decoding end, the fourth addition module in embodiments of this application may be the adder 207 in FIG. 2.

Further, the reconstructed image of the current image may be reconstructed according to the reconstructed image feature. In some embodiments, the performing the feature enhancement and the reconstruction processing on the reconstructed image feature, to determine the reconstructed image of the current image may include: performing the feature enhancement and the reconstruction processing on the reconstructed image feature by using a reconstruction and enhancement module, to determine the reconstructed image of the current image.

It should be further noted that, in embodiments of this application, the reconstruction and enhancement module is a network structure used to implement feature enhancement and reconstruction, and may also be referred to as an “enhancement and reconstruction network”. The reconstruction and enhancement module includes at least one residual module, a fifth addition module, and a deconvolutional module. Correspondingly, in some embodiments, the performing the feature enhancement and the reconstruction processing on the reconstructed image feature by using the reconstruction and enhancement module, to determine the reconstructed image of the current image may include:
performing feature extraction on the reconstructed image feature by using the at least one residual module, to obtain a sixth intermediate feature;
performing an addition operation on the sixth intermediate feature and the reconstructed image feature by using the fifth addition module, to obtain a seventh intermediate feature; and
performing a deconvolution operation on the seventh intermediate feature by using the deconvolutional module, to obtain the reconstructed image of the current image.

It should be further noted that in embodiments of this application, the deconvolutional module may include a deconvolutional layer. An internal structure of the deconvolutional module and a specific quantity of deconvolutional layers are not limited herein. In addition, for the reconstruction and enhancement module, a quantity of residual modules may be 3, but may alternatively be another number. A specific quantity of residual modules is not limited herein.

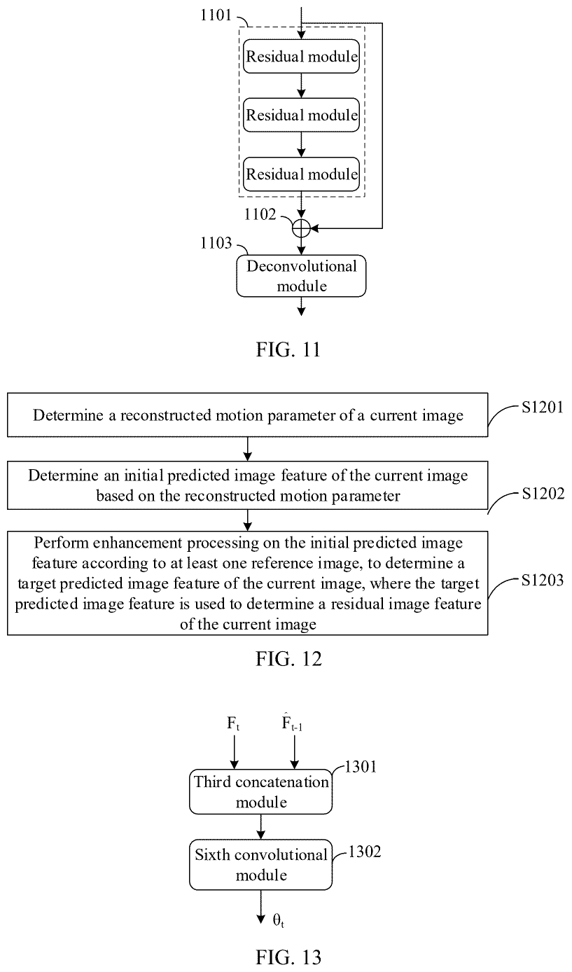

Exemplarily, FIG. 11 is a schematic structural diagram of a reconstruction and enhancement module according to an embodiment of this application. As shown in FIG. 11, the reconstruction and enhancement module may include three residual modules 1101, a fifth addition module 1102, and a deconvolutional module 1103. The deconvolutional module 1103 may include a deconvolutional layer, which is denoted as DeConv(3,5,2). The residual module may be denoted as Resblock(64,3). In this way, first, feature extraction is performed on a reconstructed image feature by using the three residual modules 1101 successively, to obtain a sixth intermediate feature. Then, the fifth addition module 1102 performs an addition operation on the sixth intermediate feature and the reconstructed image feature, to obtain a seventh intermediate feature. Finally, the deconvolutional module 1103 performs a deconvolution operation on the seventh intermediate feature, to obtain a reconstructed image of a current image.

It should be noted that in embodiments of this application, for an internal structure of the residual module, reference may be made to FIG. 7. In addition, for the deconvolutional layer, a quantity of channels may be set to 3, a size of a convolutional kernel may be 5×5, and a step may be set to 2. However, it should be noted that, for the deconvolutional layer in the deconvolutional module 1103, a convolution parameter (for example, a size of a convolutional kernel or a quantity of channels) is not fixed design, and may be adjusted herein. A specific value is not limited.

Further, in embodiments of this application, one bit (which is specifically first identification information) may be encoded in a bitstream, to indicate whether a predicted image feature enhancement mode is used for the current image. Therefore, in some embodiments, the method may further include:
decoding the bitstream, to determine a value of the first identification information; and
if the first identification information indicates that the predicted image feature enhancement mode is used for the current image, executing the performing the enhancement processing on the initial predicted image feature according to the at least one reference image, to determine the target predicted image feature of the current image.

It should be noted that, in embodiments of this application, the first identification information may be one predefined indicator bit to be written into the bitstream, and is used to indicate whether the predicted image feature enhancement mode is used for the current image. In this way, a decoding end may obtain the value of the first identification information through decoding, so that the decoding end can quickly determine whether to use the predicted image feature enhancement mode.

It should be further noted that, in embodiments of this application, if the first identification information indicates that the predicted image feature enhancement mode is used for the current image, the step of enhancement processing shown in FIG. 3 is executed, that is, the enhancement processing is performed on the initial predicted image feature according to the at least one reference image, to determine the target predicted image feature of the current image. Alternatively, if the first identification information indicates that the predicted image feature enhancement mode is not used for the current image, the step of enhancement processing shown in FIG. 3 is no longer executed. In this case, the obtained initial predicted image feature is directly used as the target predicted image feature of the current image.

In some embodiments, for the value of the first identification information, the method may further include:
if the value of the first identification information is a first value, determining that the first identification information indicates that the predicted image feature enhancement mode is used for the current image; or
if the value of the first identification information is a second value, determining that the first identification information indicates that the predicted image feature enhancement mode is not used for the current image.

In embodiments of this application, the first value is different from the second value, and the first value and the second value may be in a parameter form, or may be in a numeric form. Specifically, the first identification information may be a parameter written into a profile (profile), or may be a value of a flag (flag), which is not specifically limited herein.

Exemplarily, for the first value and the second value, the first value may be set to 1, and the second value may be set to 0. Alternatively, the first value may be set to 0, and the second value may be set to 1. Alternatively, the first value may be set to true, and the second value may be set to false. Alternatively, the first value may be set to false, and the second value may be set to true. However, this is not specifically limited herein.

In embodiments of this application, that the first identification information is a flag written into the bitstream is used as an example. If the first value is set to 1 and the second value is set to 0, when the value of the first identification information is 1, it may be determined that the predicted image feature enhancement mode is used for the current image. In this case, the enhancement processing needs to be performed on the initial predicted image feature according to the at least one reference image, to determine the target predicted image feature of the current image. Alternatively, when the value of the first identification information is 0, it may be determined that the predicted image feature enhancement mode is not used for the current image. In this case, the obtained initial predicted image feature is directly used as the target predicted image feature of the current image.

Further, in embodiments of this application, a preset network model may be trained by using a same training method as that in a related technology, that is, end-to-end training is performed on all modules of an entire video compression network. Therefore, in some embodiments, the method may further include:
determining a preset network model; and
performing end-to-end training on the preset network model, to determine a target network model, where the target network model is used to perform encoding, decoding and reconstruction operations on the current image.

The preset network model includes an initial network model and a prediction enhancement module, and the initial network model includes at least a feature extraction module, a motion parameter generation module, an autoencoder, a predicted feature generation module, and a reconstruction and enhancement module.

That is, in embodiments of this application, the prediction enhancement module may be embedded into an existing initial network model, and is configured to further enhance a predicted image feature after an initial predicted image feature is generated through motion compensation, to generate an enhanced target predicted image feature. Specifically, network models in embodiments of this application may be end-to-end trained together with the initial network model, so that a training method of the initial network model does not need to be changed, thereby greatly simplifying a training process of the video compression network. The autoencoder herein may include a motion parameter autoencoder and a residual autoencoder.

It may be learned from the above that in embodiments of this application, the following technical problems are mainly resolved herein. On the one hand, in a conventional process of generating a predicted image feature, a motion vector representation (offset) in motion estimation needs to be used, and the motion vector representation (offset) needs to be compressed and transmitted to a decoding end. This process is lossy. Therefore, a reconstructed motion vector representation (offset) is distorted, and correspondingly a generated predicted image feature is distorted. In embodiments of this application, a reconstructed image at a past instant is used to enhance the predicted image feature, thereby improving quality of a predicted image and reducing distortion of the predicted image. On the other hand, a predicted image of a current image cannot be well generated by using a single reference image, for example, due to an occluded region caused by motion. However, the occluded region may be included in a previous image. Therefore, embodiments of this application propose to enhance the predicted image by using a reconstructed image at a past instant. In conclusion, embodiments of this application can effectively improve quality of a predicted image feature.

Exemplarily, after the prediction enhancement technology in embodiments of this application is embedded into the FVC solution, encoding and decoding efficiency can be effectively improved. A test result is shown in Table 1. Table 1 shows an improvement effect of the prediction enhancement technology in embodiments of this application relative to the FVC solution. Specifically, the improvement lies in the Bjøntegaard delta bit rate (Bjøntegaard Delta Bit Rate, BDBR).

TABLE 1

| Test sequence | Test result (%) |
|---|---|
| HEVC Class B | −4.13 |
| HEVC Class C | −2.14 |
| HEVC Class D | −2.28 |
| UVG | −6.37 |
| Average (Average) | −3.73 |

It can be learned from Table 1 that, compared with the FVC solution, an average Bjøntegaard delta bit rate (BDBR) in embodiments of this application is about 3.73%.

It should be further noted that, in embodiments of this application, the prediction enhancement technology herein may be applied not only to the FVC solution but also to the DCVC solution, and may even be applied to another video encoding network solution, which is not limited herein.

This embodiment provides a decoding method. First, a bitstream is decoded, to determine a reconstructed motion parameter of a current image. Then, an initial predicted image feature of the current image is determined based on the reconstructed motion parameter. Then, enhancement processing is performed on the initial predicted image feature according to at least one reference image, to determine a target predicted image feature of the current image, where the target predicted image feature is used to determine a reconstructed image of the current image. In this way, a predicted image at a current instant is enhanced by using reconstructed images at past instants, thereby improving quality of the predicted image. This process includes: separately using the reconstructed images at the past instants to correct the predicted image at the current instant, and then fusing the predicted images corrected by multiple images with the predicted image at the current instant, to generate a predicted image with higher quality. Therefore, according to the high-quality predicted image, quality of the reconstructed images of the current image can be improved, encoding and decoding efficiency can be improved, and video encoding and decoding performance can be improved.

In another embodiment of this application, referring to FIG. 12, FIG. 12 is a schematic flowchart of an encoding method according to an embodiment of this application. As shown in FIG. 12, the method may include the following steps.

S1201: Determine a reconstructed motion parameter of a current image.

It should be noted that the encoding method in embodiments of this application is applied to an encoder. In addition, the encoding method may specifically refer to a method for generating a predicted image enhanced based on multiple images. In addition, the method is embedded in a video encoding loop. Both an encoding end and a decoding end may enhance a predicted image feature generated in a conventional manner of motion compensation by using a plurality of reconstructed reference images, thereby improving quality of a predicted image.

It should be further noted that, in embodiments of this application, the reconstructed motion parameter of the current image may be denoted as et. At the encoding end, first, a first motion parameter of the current image needs to be determined, and then the reconstructed motion parameter of the current image may be obtained by performing encoding and decoding processing on the first motion parameter. In some embodiments, the determining the reconstructed motion parameter of the current image may include:
determining a first reference image;
determining a first motion parameter based on the first reference image and the current image; and
performing encoding and decoding processing on the first motion parameter, to determine the reconstructed motion parameter of the current image.

That is, in embodiments of this application, the encoding end first needs to determine the first motion parameter and then write the first motion parameter into a bitstream. Subsequently, the decoding end can directly obtain the reconstructed motion parameter of the current image by decoding the bitstream. The first motion parameter may also be referred to as a “motion vector representation-offset”, which may be denoted as θₜ herein.

It should be further noted that, in embodiments of this application, the first reference image may be adjacent to the current image, and the first reference image is a reconstructed image of an image preceding to the current image by one frame. That is, if the current image is Xₜ, the first reference image may be \hat{X}ₜ₋₁, where t is a positive integer.

In some embodiments, the determining the first motion parameter based on the first reference image and the current image may include: separately performing feature extraction on the current image and the first reference image, to determine a current image feature and a first reference image feature; and performing motion estimation according to the first reference image feature and the current image feature, to determine the first motion parameter.

Further, the feature extraction of the first reference image and that of the current image may both be implemented by a feature extraction module. In some embodiments, the separately performing the feature extraction on the current image and the first reference image, to determine the current image feature and the first reference image feature may include:
performing the feature extraction on the current image by using the feature extraction module, to obtain the current image feature; and
performing the feature extraction on the first reference image by using the feature extraction module, to obtain the first reference image feature.

That is, in embodiments of this application, for the first reference image \hat{X}ₜ₋₁ and the current image Xₜ, a same feature extraction module, that is, a shared feature extraction module, is used. An extraction process is as follows:

$${F}_{t} = {f}_{feat} ( {X}_{t} ) ; {\hat{F}}_{t - 1} = {f}_{feat} ( {\hat{X}}_{t - 1} ) \qquad ( 9 )$$

Herein, f_{feat}(*) is the feature extraction module, and the feature extraction module may be shared for both the current image and a previously reconstructed reference image. The feature extraction module may include a third convolutional module, at least one residual module, and a second addition module. For a specific structure of the feature extraction module, reference is made to FIG. 6.

In a specific implementation, the performing the feature extraction on the current image by using the feature extraction module, to obtain the current image feature may include: performing feature extraction on the current image by using the third convolutional module, to obtain a first intermediate feature; performing feature extraction on the first intermediate feature by using the at least one residual module, to obtain a second intermediate feature; and performing an addition operation on the first intermediate feature and the second intermediate feature by using the second addition module, to obtain the current image feature.

In another specific implementation, the performing the feature extraction on the first reference image by using the feature extraction module, to obtain the first reference image feature may include: performing feature extraction on the first reference image by using the third convolutional module, to obtain a first intermediate feature; performing feature extraction on the first intermediate feature by using the at least one residual module, to obtain a second intermediate feature; and performing an addition operation on the first intermediate feature and the second intermediate feature by using the second addition module, to obtain the first reference image feature.

It should be noted that, in embodiments of this application, the third convolutional module may include a third convolutional layer. An internal structure of the third convolutional module and a specific quantity of third convolutional layers are not limited herein. In addition, for the feature extraction module, a quantity of residual modules may be 3, but may alternatively be another number. A specific quantity of residual modules is not limited herein.

It should be further noted that, in embodiments of this application, the residual module may be a residual-based convolutional block and belongs to a basic composition module. In some embodiments, the residual module may include at least one residual convolutional layer and at least one activation layer. The activation layer may be a non-linear activation function, and the activation function is used to add a non-linear factor, to resolve a problem that cannot be resolved by a linear model. This plays a very important role in learning and understanding a very complicated non-linear function by an artificial neural network model. Exemplarily, the activation function may be a Sigmoid function, a Tanh function, a rectified linear unit (The Rectified Linear Unit, ReLU) function, or the like. In embodiments of this application, the ReLU function may be used as the activation layer, but is not limited. In addition, the residual module may include only one residual convolutional layer, or may include two or more residual convolutional layers, which is not limited herein.

It should be further noted that, in embodiments of this application, the feature extraction module shown in FIG. 6 and the residual module shown in FIG. 7 are only exemplary network structures. However, a person skilled in the art may learn that the network structures of the feature extraction module and the residual module are not limited thereto.

In some embodiments, after the first reference image feature and the current image feature are obtained through extraction, the performing the motion estimation according to the first reference image feature and the current image feature, to determine the first motion parameter may include: performing the motion estimation on the first reference image feature and the current image feature by using a motion parameter generation module, to determine the first motion parameter.

It may be understood that, in embodiments of this application, the motion parameter generation module is a network structure used to generate a motion vector representation, that is, an offset (offset), which may also be referred to as a “motion vector representation generation network”. The motion parameter generation module includes a third concatenation module and a sixth convolutional module. Correspondingly, in some embodiments, the performing the motion estimation on the first reference image feature and the current image feature by using the motion parameter generation module, to obtain the first motion parameter may include:
performing a concatenation operation on the first reference image feature and the current image feature by using the third concatenation module, to obtain an eighth intermediate feature; and
performing a convolution operation on the eighth intermediate feature by using the sixth convolutional module, to obtain the first motion parameter.

It should be noted that, in embodiments of this application, the third concatenation module may include a third concatenation layer, and the sixth convolutional module may include a sixth convolutional layer.

It should be further noted that, in embodiments of this application, a specific internal structure of the third concatenation module or the sixth convolutional module is not limited. For example, a quantity of sixth convolutional layers may be 1, 2, or even more. In addition, convolution parameters (such as a size of a convolutional kernel and a quantity of channels) of these convolutional layers may be the same or different. This is not limited herein.

Exemplarily, FIG. 13 is a schematic structural diagram of a motion parameter generation module according to an embodiment of this application. As shown in FIG. 13, the motion parameter generation module may include a third concatenation module 1301 and a sixth convolutional module 1302. First, a current image feature Fₜ and a first reference image feature \hat{F}ₜ₋₁ are input to the third concatenation module 1301, and then the sixth convolutional module 1302 performs a convolution operation on an eighth intermediate feature obtained by concatenation, to obtain a first motion parameter θₜ of a current image.

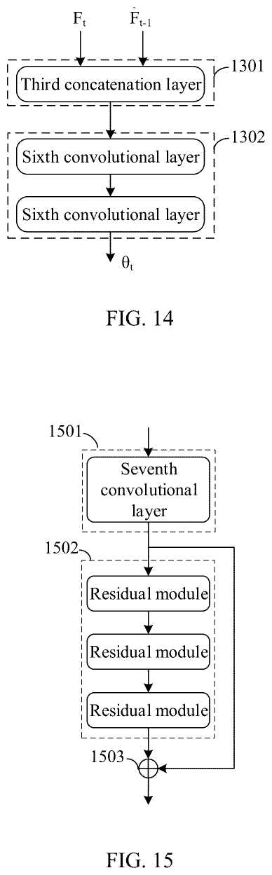

Exemplarily, FIG. 14 is a schematic diagram of a detailed structure of a motion parameter generation module according to an embodiment of this application. As shown in FIG. 14, the third concatenation module 1301 may include a third concatenation layer, and the sixth convolutional module 1302 may include two sixth convolutional layers. The third concatenation layer may be denoted as Cat, and the sixth convolutional layers may be denoted as Conv(64,3,1). Specifically, a quantity of channels is set to 64, a size of a convolutional kernel may be 3×3, and a step is set to 1. However, it should be noted that convolution parameters (such as a size of a convolutional kernel and a quantity of channels) of the sixth convolutional layers are not fixed design, and may be adjusted herein. Specific values are not limited.

Herein, a motion vector representation-offset (that is, a first motion parameter θₜ) is generated by performing a convolution operation on a feature obtained by concatenating a current image feature Fₜ and a first reference image feature \hat{F}ₜ₋₁. A specific process is as follows:

$${θ}_{t} = {f}_{offset} ( c a t ( {F}_{t} , {\hat{F}}_{t - 1} ) ) \qquad ( 10 )$$

Herein, cat(*) is a concatenation operation of the third concatenation module 1301, and f_{offset}(*) is an offset generation network, which is a two-layer convolutional network of the sixth convolutional module 1302 herein.

Further, in embodiments of this application, encoding and decoding processing based on an autoencoder needs to be performed on the first motion parameter et, to generate a reconstructed motion parameter. In some embodiments, the performing the encoding and decoding processing on the first motion parameter, to determine the reconstructed motion parameter of the current image may include: performing the encoding and decoding processing on the first motion parameter by using the autoencoder, to determine the reconstructed motion parameter of the current image.

It may be further understood that, in embodiments of this application, the autoencoder may include an encoding module and a decoding module. Correspondingly, in some embodiments, the performing the encoding and decoding processing on the first motion parameter by using the autoencoder, to determine the reconstructed motion parameter of the current image may include: performing the encoding processing on the first motion parameter by using the encoding module of the autoencoder, and writing an obtained encoded bit into a bitstream; and performing the decoding processing on the bitstream by using the decoding module of the autoencoder, to obtain the reconstructed motion parameter of the current image.

It should be noted that in embodiments of this application, a structure of the encoding module is similar to that of the decoding module, and the decoding module is an inverse process of the encoding module. In addition, in an encoding process based on the autoencoder, not only the encoding module of the autoencoder is required, but also encoding of an entropy encoding module is required, to generate the bitstream. Then, the bitstream needs to be decoded by the entropy decoding module and decoded by the decoding module of the autoencoder, to generate the reconstructed motion parameter \hat{θ}ₜ. A specific process is as follows:

$${\hat{θ}}_{t} = {f}_{d e c o d e r} ( Q ( {f}_{e n c o d e r} ( {θ}_{t} ) ) ) \qquad ( 11 )$$

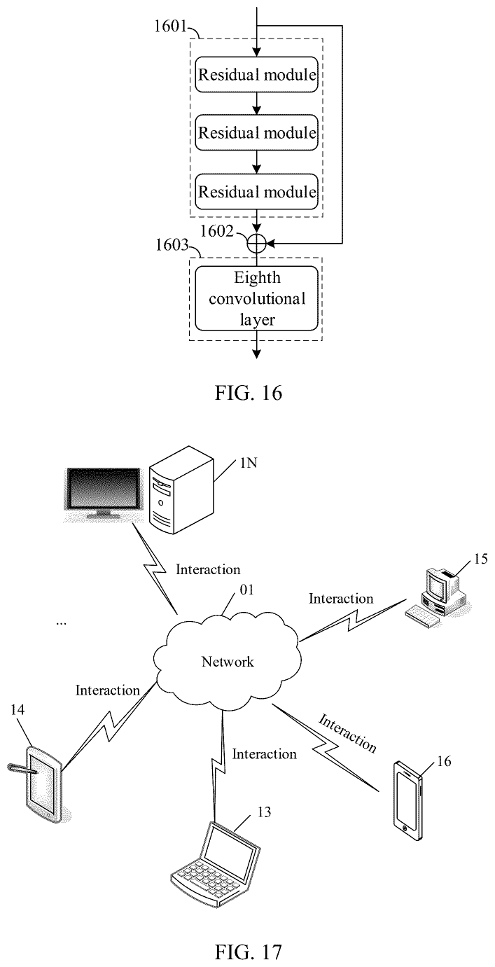

Herein, f_{encoder}(*), f_{decoder}(*) is an encoding module and a decoding module of a motion parameter autoencoder, which are respectively shown in FIG. 15 and FIG. 16, and Q(*) is a quantization process.

Exemplarily, for an autoencoder, FIG. 15 is a schematic structural diagram of an encoding module of the autoencoder according to an embodiment of this application. As shown in FIG. 15, the encoding module of the autoencoder may include a seventh convolutional module 1501, at least one residual module 1502, and a sixth addition module 1503. The seventh convolutional module 1501 may include a seventh convolutional layer, and the at least one residual module 1502 may include three residual modules. Exemplarily, the residual modules may be denoted as Resblock(128,3), and the seventh convolutional layer may be denoted as Conv(128,5,2). Specifically, a quantity of channels is set to 128, a size of a convolutional kernel may be 5×5, and a step is set to 2. However, it should be noted that a convolution parameter (for example, a size of a convolutional kernel or a quantity of channels) of the seventh convolutional layer is not fixed design, and may be adjusted herein. A specific value is not limited.

Exemplarily, for an autoencoder, FIG. 16 is a schematic structural diagram of a decoding module of the autoencoder according to an embodiment of this application. As shown in FIG. 16, the decoding module of the autoencoder may include at least one residual module 1601, a seventh addition module 1602, and an eighth convolutional module 1603. The at least one residual module 1601 may include three residual modules, and the eighth convolutional module 1603 may include an eighth convolutional layer, where the eighth convolutional layer is a transposed convolutional layer (or referred to as a “deconvolutional layer”) of a seventh convolutional layer. Exemplarily, the residual modules may be denoted as Resblock(128,3), and the eighth convolutional layer may be denoted as DeConv(128,5,2). Specifically, a quantity of channels is set to 128, a size of a convolutional kernel may be 5×5, and a step is set to 2. However, it should be noted that a convolution parameter (for example, a size of a convolutional kernel or a quantity of channels) of the eighth convolutional layer is not fixed design, and may be adjusted herein. A specific value is not limited.

In embodiments of this application, for the autoencoder, both the encoding module shown in FIG. 15 and the decoding module shown in FIG. 16 are exemplary network structures. However, a person skilled in the art may learn that the network structures of the encoding module and the decoding module of the autoencoder are not limited thereto.

S1202: Determine an initial predicted image feature of the current image based on the reconstructed motion parameter.

It should be noted that after the reconstructed motion parameter \hat{θ}ₜ is determined, the initial predicted image feature of the current image may be further determined. In some embodiments, the determining the initial predicted image feature of the current image based on the reconstructed motion parameter may include:
determining a first reference image;
performing feature extraction on the first reference image, to determine a first reference image feature; and
performing motion compensation according to the first reference image feature and the reconstructed motion parameter, to determine the initial predicted image feature.

In embodiments of this application, the first reference image may be adjacent to the current image, and the first reference image is a reconstructed image of an image preceding to the current image by one frame. That is, if the current image is Xₜ, the first reference image may be \hat{X}ₜ₋₁, where t is a positive integer.

In embodiments of this application, the feature extraction of the first reference image may be implemented by a feature extraction module. In some embodiments, the performing the feature extraction on the first reference image, to determine the first reference image feature may include: performing the feature extraction on the first reference image by using the feature extraction module, to determine the first reference image feature. The feature extraction module may include a third convolutional module, at least one residual module, and a second addition module. For a specific structure of the feature extraction module, reference is made to FIG. 6.

In some embodiments, after the first reference image feature is obtained through extraction, the performing the motion compensation according to the first reference image feature and the reconstructed motion parameter, to determine the initial predicted image feature may include: performing the motion compensation on the first reference image feature and the reconstructed motion parameter by using a predicted feature generation module, to determine the initial predicted image feature.

It may be understood that, in embodiments of this application, the predicted feature generation module is a network structure used to implement generation of the initial predicted image feature, and may also be referred to as a “predicted image feature generation network”. The predicted feature generation module includes a fourth convolutional module, a second concatenation module, a fifth convolutional module, and a third addition module. Correspondingly, in some embodiments, the performing the motion compensation on the first reference image feature and the reconstructed motion parameter by using the predicted feature generation module, to determine the initial predicted image feature may include:
performing a deformable convolution operation on the reconstructed motion parameter and the first reference image feature by using the fourth convolutional module, to obtain a third intermediate feature;
performing a concatenation operation on the third intermediate feature and the first reference image feature by using the second concatenation module, to obtain a fourth intermediate feature;
performing a convolution operation on the fourth intermediate feature by using the fifth convolutional module, to obtain a fifth intermediate feature; and
performing an addition operation on the third intermediate feature and the fifth intermediate feature by using the third addition module, to obtain the initial predicted image feature.

It should be noted that, in embodiments of this application, the fourth convolutional module may include a second deformable convolutional layer, the second concatenation module may include a second concatenation layer, and the fifth convolutional module may include a fifth convolutional layer.

It should be further noted that, a specific internal structure of the fourth convolutional module, the second concatenation module, or the fifth convolutional module is not limited in embodiments of this application. For example, there may be at least one second deformable convolutional layer, and there may also be at least one fifth convolutional layer. Convolution parameters (such as a size of a convolutional kernel and a quantity of channels) of these convolutional layers may be the same or different. This is not limited herein.

Exemplarily, FIG. 8 and FIG. 9 show examples of a structure of a predicted feature generation module according to an embodiment of this application, but are not limited thereto. The second deformable convolutional layer may be denoted as Deformable Conv, the second concatenation layer may be denoted as Cat, and the fifth convolutional layer may be denoted as Conv(64,3,1). Specifically, a quantity of channels is set to 64, a size of a convolutional kernel may be 3×3, and a step is set to 1. However, it should be noted that a convolution parameter (for example, a size of a convolutional kernel or a quantity of channels) of the fifth convolutional layer is not fixed design, and may be adjusted herein. A specific value is not limited.

Herein, the second deformable convolutional layer is used to perform a convolution operation on the reconstructed motion parameter et and the first reference image feature \hat{F}ₜ₋₁, to finally generate an initial predicted image feature Pₜ (that is, motion compensation). A specific process is as follows:

$${P}_{t} = {f}_{e n {c}_{p r e}} ( D c o n v ( {\hat{F}}_{t - 1} , {\hat{θ}}_{t} ) ) \qquad ( 12 )$$

Herein, Dconv(*) is the second deformable convolutional layer of the fourth convolutional module 801, and f_{enc}_{ₚᵣₑ} is a two-layer convolutional network of the fifth convolutional module 803 for feature enhancement. Finally, the initial predicted image feature Pₜ can be generated.

S1203: Perform enhancement processing on the initial predicted image feature according to at least one reference image, to determine a target predicted image feature of the current image, where the target predicted image feature is used to determine a residual image feature of the current image.

It should be noted that, in embodiments of this application, after being obtained, the reconstructed motion parameter may be used to determine the initial predicted image feature of the current image. Then, the enhancement processing is performed on the initial predicted image feature according to the at least one reference image, to obtain a high-quality reconstructed image.

In some embodiments, the performing the enhancement processing on the initial predicted image feature according to the at least one reference image, to determine the target predicted image feature of the current image may include:
separately performing feature extraction on the at least one reference image, to determine at least one reference image feature; and
performing the enhancement processing on the initial predicted image feature according to the at least one reference image feature, to determine the target predicted image feature.

It should be further noted that in embodiments of this application, the at least one reference image is a reconstructed image, and the reference image may be a reconstructed image of an image preceding to the current image by m frames, where m is an integer greater than or equal to 1.

It should be further noted that, in embodiments of this application, each reference image is used to extract a respective reference image feature, and then the enhancement processing is performed on the initial predicted image feature by using the reference image feature. The enhancement processing may be implemented by a prediction enhancement module. In some embodiments, the performing the enhancement processing on the initial predicted image feature according to the at least one reference image feature, to determine the target predicted image feature may include: performing an enhancement operation on the at least one reference image feature and the initial predicted image feature by using the prediction enhancement module, to determine the target predicted image feature.

It may be understood that, in embodiments of this application, the prediction enhancement module may be a network structure for generating a target predicted image feature by enhancement based on a plurality of reference images. The prediction enhancement module includes a first convolutional module, a first concatenation module, a second convolutional module, and a first addition module. Correspondingly, in some embodiments, the performing the enhancement operation on the at least one reference image feature and the initial predicted image feature by using the prediction enhancement module, to determine the target predicted image feature may include:
separately using the at least one reference image feature to perform a convolution operation with the initial predicted image feature by using the first convolutional module, to obtain at least one correction feature;
performing a concatenation operation on the at least one correction feature and the initial predicted image feature by using the first concatenation module, to obtain a concatenated feature;
performing convolutional fusion processing on the concatenated feature by using the second convolutional module, to obtain a fused correction feature; and
performing an addition operation on the fused correction feature and the initial predicted image feature by using the first addition module, to obtain the target predicted image feature.

It should be noted that in embodiments of this application, the first convolutional module may include at least one convolutional submodule, and a quantity of the at least one convolutional submodule has a correspondence with a quantity of the at least one reference image.

That is, in embodiments of this application, each convolutional submodule may perform a convolution operation on a reference image feature and the initial predicted image feature, to obtain a corresponding correction feature. Then, the first concatenation module performs a concatenation operation on the correction features and the initial predicted image feature, and the second convolutional module performs convolutional fusion on a concatenated feature, to obtain a fused correction feature. Finally, the first addition module performs summation calculation on the fused correction feature and the initial predicted image feature, to obtain the target predicted image feature.

Exemplarily, FIG. 4 shows an example of a structure of a prediction enhancement module according to an embodiment of this application, but this application is not limited thereto. The initial predicted image feature may be denoted as Pₜ, the first reference image feature may be denoted as \hat{F}ₜ₋₁, the second reference image feature may be denoted as \hat{F}ₜ₋₂, and the n reference image feature may be denoted as \hat{F}ₜ₋ₙ. Specifically, the convolutional submodule 1 is configured to perform a convolution operation on \hat{F}ₜ₋₁ and Pₜ, to generate a first correction feature, which is denoted as Pₜ₋₁. The convolutional submodule 2 is configured to perform a convolution operation on \hat{F}ₜ₋₂ and Pₜ, to generate a second correction feature, which is denoted as Pₜ₋₂. The convolutional submodule n is configured to perform a convolution operation on \hat{F}ₜ₋ₙ and Pₜ, to generate an n correction feature, which is denoted as Pₜ₋ₙ. Then, the first concatenation module 402 performs a concatenation operation on Pₜ, Pₜ₋₁, Pₜ₋₂, . . . , and Pₜ₋ₙ, and the second convolutional module 403 performs convolutional fusion, to generate a fused correction feature, which is denoted as \tilde{P}ₜᵣ. Finally, the first addition module 404 performs an addition operation on Pₜ and \tilde{P}ₜᵣ by using a residual structure, to obtain a final target predicted image feature, which is denoted as \tilde{P}ₜ.

In a specific implementation, a convolutional submodule may include a first convolutional layer and a first deformable convolutional layer, the first concatenation module may include a first concatenation layer, and the second convolutional module may include a second convolutional layer. For details, reference is made to FIG. 5. The first deformable convolutional layer may be denoted as Deformable Conv, and the first concatenation layer may be denoted as Cat. A convolution parameter of the first convolutional layer and that of the second convolutional layer may be the same or different. For example, a quantity of channels of the first convolutional layer is set to 64, a size of a convolutional kernel is 3×3, and a step is set to 1, that is, the first convolutional layer may be denoted as Conv(64,3,1). A quantity of channels of the second convolutional layer is set to 64, a size of a convolutional kernel is 1×1, and a step is set to 1, that is, the second convolutional layer may be denoted as Conv(64,1,1). However, it should be noted that convolution parameters (such as a size of a convolutional kernel and a quantity of channels) of the first convolutional layer and the second convolutional layer are not fixed design, and may be adjusted herein. Specific values are not limited.

In embodiments of this application, for a convolutional submodule, a concatenation operation may be performed on an initial predicted image feature and a reference image feature, and then an offset between the reference image feature and the initial predicted image feature may be generated by using the first convolutional layer and a corresponding activation function. A specific process is as follows:

$${o}_{t - n} = c o n v ( r e l u ( c o n v ( c a t ( {\hat{F}}_{t - n} , {P}_{t} ) ) ) ) \qquad ( 13 )$$

After the offset is acquired, a deformable convolution operation may be performed by using the first deformable convolutional layer, to generate a corresponding correction feature from a reconstructed image at a past instant. A specific process is as follows:

$${P}_{t - n} = D c o n v ( {\hat{F}}_{t - n} , {o}_{t - n} ) \qquad ( 14 )$$

A concatenation operation is performed on at least one generated correction feature and the initial predicted image feature, and convolutional fusion processing is performed by using the second convolutional layer, to finally generate a fused correction feature. A specific process is as follows:

$${\tilde{P}}_{tr} = c o n v ( c a t ( {P}_{t} , {P}_{t - 1} , {P}_{t - 2} , … , {P}_{t - n} ) \qquad ( 15 )$$

Finally, an addition operation is performed on the fused correction feature and the initial predicted image feature by using a residual structure, to generate a final target predicted image feature. A specific process is as follows:

$${\tilde{P}}_{t} = {\tilde{P}}_{tr} + {P}_{t} \qquad ( 16 )$$

In another specific implementation, the convolutional submodule may include a first convolutional layer, the first concatenation module may include a first concatenation layer, and the second convolutional module may include a second convolutional layer.

That is, in embodiments of this application, for each convolutional submodule, a process of using the reference image feature to correct a current predicted image by a deformable convolutional layer may be directly implemented through convolution, that is, the first deformable convolutional layer may be omitted herein. In this case, the initial predicted image feature is directly fused with a reference image feature at a past instant, and then a final target predicted image feature is generated through convolution.

It should be noted that, a specific internal structure of the first convolutional module, the first concatenation module, or the second convolutional module is not limited in embodiments of this application. For example, there may be at least one first convolutional layer, and there may also be at least one second convolutional layer. Convolution parameters (such as a size of a convolutional kernel and a quantity of channels) of these convolutional layers may be the same or different. This is not limited herein.

It should be further noted that, in embodiments of this application, the final target predicted image feature may be directly generated without using the residual structure. Specifically, in generating the target predicted image feature, the residual structure may be used, that is, an addition operation may be performed on the initial predicted image feature and the fused correction feature that is enhanced by using at least one reference image. However, the addition operation may alternatively not be used herein, and the initial predicted image feature and the fused correction feature are directly concatenated, to generate the final target predicted image feature. That is, the first addition module may not be required herein, which is not limited.

It may be further understood that in embodiments of this application, the enhancement processing is performed according to the at least one reference image feature herein. Therefore, first, a reference image feature corresponding to each reference image needs to be extracted. In some embodiments, the separately performing the feature extraction on the at least one reference image, to determine the at least one reference image feature may include: separately performing the feature extraction on the at least one reference image by using a feature extraction module, to determine the at least one reference image feature.

That is, the feature extraction may be implemented by the feature extraction module. A same feature extraction module may be used for the at least one reference image. Exemplarily, there are three reference images, for example, a first reference image, a second reference image, and a third reference image. In some embodiments, the separately performing the feature extraction on the at least one reference image by using the feature extraction module, to determine the at least one reference image feature may include:
performing the feature extraction on the first reference image by using the feature extraction module, to obtain a first reference image feature;
performing the feature extraction on the second reference image by using the feature extraction module, to obtain a second reference image feature;
performing the feature extraction on the third reference image by using the feature extraction module, to obtain a third reference image feature; and
determining the first reference image feature, the second reference image feature, and the third reference image feature as the at least one reference image feature.

It should be noted that in embodiments of this application, if three reference images are used to perform the enhancement processing on the initial predicted image feature, specifically, the first reference image feature, the second reference image feature, and the third reference image feature may be used to perform the enhancement processing on the initial predicted image feature, to generate the target predicted image feature.

In a specific embodiment, the first reference image is a reconstructed image of an image preceding to the current image by one frame, the second reference image is a reconstructed image of an image preceding to the current image by two frames, and the third reference image is a reconstructed image of an image preceding to the current image by three frames.

In embodiments of this application, the first reference image may be denoted as \hat{X}ₜ₋₁, and the first reference image feature may be denoted as \hat{F}ₜ₋₁. The second reference image may be denoted as \hat{X}ₜ₋₂, and the second reference image feature may be denoted as \hat{F}ₜ₋₂. The third reference image may be denoted as \hat{X}ₜ₋₃, and the third reference image feature may be denoted as \hat{F}ₜ₋₃. Specifically, a feature extraction process is as follows:

$${\hat{F}}_{t - 1} = {f}_{feat} ( {\hat{X}}_{t - 1} ) ; {\hat{F}}_{t - 2} = {f}_{feat} ( {\hat{X}}_{t - 2} ) ; {\hat{F}}_{t - 3} = {f}_{feat} ( {\hat{X}}_{t - 3} ) \qquad ( 17 )$$

Herein, f_{feat}(*) denotes the feature extraction module, which is configured to separately perform the feature extraction on the at least one reference image.

It should be noted that, in embodiments of this application, a quantity of reference image features may be 1, 2, 3, or even more. In this case, that three reference images are used to extract corresponding reference image features is merely used as an example. However, a specific quantity of reference images and a specific quantity of reference image features are not limited.

It should be further noted that in embodiments of this application, a same feature extraction module, that is, a shared feature extraction module, is used for the at least one reference image and the current image. The feature extraction module may include a third convolutional module, at least one residual module, and a second addition module. For a specific structure of the feature extraction module, reference is made to FIG. 6.

In a specific implementation, the feature extraction of the first reference image \hat{X}ₜ₋₁ is used as an example. The performing the feature extraction on the first reference image by using the feature extraction module, to obtain the first reference image feature may include: performing feature extraction on the first reference image by using the third convolutional module, to obtain a first intermediate feature; performing feature extraction on the first intermediate feature by using the at least one residual module, to obtain a second intermediate feature; and performing an addition operation on the first intermediate feature and the second intermediate feature by using the second addition module, to obtain the first reference image feature \hat{F}ₜ₋₁.

In another specific implementation, the feature extraction of the second reference image \hat{X}ₜ₋₂ is used as an example. The performing the feature extraction on the second reference image by using the feature extraction module, to obtain the second reference image feature may include: performing feature extraction on the second reference image by using the third convolutional module, to obtain a first intermediate feature; performing feature extraction on the first intermediate feature by using the at least one residual module, to obtain a second intermediate feature; and performing an addition operation on the first intermediate feature and the second intermediate feature by using the second addition module, to obtain the second reference image feature \hat{F}ₜ₋₂.

In still another specific implementation, the feature extraction of the third reference image \hat{X}ₜ₋₃ is used as an example. The performing the feature extraction on the third reference image by using the feature extraction module, to obtain the third reference image feature may include: performing feature extraction on the third reference image by using the third convolutional module, to obtain a first intermediate feature; performing feature extraction on the first intermediate feature by using the at least one residual module, to obtain a second intermediate feature; and performing an addition operation on the first intermediate feature and the second intermediate feature by using the second addition module, to obtain the third reference image feature \hat{F}ₜ₋₃.

In this way, in embodiments of this application, at least one reference image feature (for example, \hat{F}ₜ₋₁, \hat{F}ₜ₋₂, and \hat{F}ₜ₋₃) is respectively extracted according to at least one reference image, and the at least one reference image feature is separately concatenated with the initial predicted image feature generated through motion compensation, to generate an offset for deformable convolution. Then, the reference image feature is processed through deformable convolution, to generate a correction feature (which may also be referred to as a “compensation feature”) corresponding to the reference image feature. After concatenation and convolutional fusion processing are performed on the compensation feature and the initial predicted image feature, a fused correction feature may be obtained. Then, an addition operation is performed on the obtained fused correction feature and the initial predicted image feature, to generate a final target predicted image feature \tilde{P}ₜ, that is, the compensation feature is used to correct the current initial predicted image feature.

Further, after the target predicted image feature is obtained, a reconstructed image of a current image may be determined based on the target predicted image feature. In some embodiments, the method may further include:
determining a reconstructed residual feature of the current image;
determining a reconstructed image feature based on the reconstructed residual feature and the target predicted image feature; and
performing feature enhancement and reconstruction processing on the reconstructed image feature, to determine the reconstructed image of the current image.

It should be noted that in embodiments of this application, the determining the reconstructed residual feature of the current image may include: determining a current image feature corresponding to the current image; determining the residual image feature based on the current image feature and the target predicted image feature; and performing encoding and decoding processing on the residual image feature, to determine the reconstructed residual feature of the current image.

In some embodiments, the determining the residual image feature based on the current image feature and the target predicted image feature may include: performing a subtraction operation on the current image feature and the target predicted image feature by using a first subtraction module, to obtain the residual image feature.

It should be further noted that in embodiments of this application, the residual image feature may be denoted as Rₜ, and the reconstructed residual feature is denoted as \tilde{R}ₜ. Herein, subtraction is performed on the current image feature and the target predicted image feature by using the first subtraction module, to generate the residual image feature, that is, Rₜ=\hat{F}ₜ−\tilde{P}ₜ. For an encoding end, the first subtraction module in embodiments of this application may be the subtractor 108 in FIG. 1.

Further, in embodiments of this application, encoding and decoding processing based on an autoencoder needs to be performed on the residual image feature Rₜ. In some embodiments, the performing the encoding and decoding processing on the residual image feature, to determine the reconstructed residual feature of the current image may include: performing the encoding and decoding processing on the residual image feature by using the autoencoder, to determine the reconstructed residual feature of the current image.

It may be further understood that, in embodiments of this application, the autoencoder may include an encoding module and a decoding module. Correspondingly, in some embodiments, the performing the encoding and decoding processing on the residual image feature by using the autoencoder, to determine the reconstructed residual feature of the current image may include: performing the encoding processing on the residual image feature by using the encoding module of the autoencoder, and writing an obtained encoded bit into a bitstream; and performing the decoding processing on the bitstream by using the decoding module of the autoencoder, to obtain the reconstructed residual feature of the current image.

It should be noted that, in embodiments of this application, for a residual autoencoder, a structure of an encoding module is similar to that of a decoding module, and the decoding module is an inverse process of the encoding module. In addition, in an encoding process based on the residual autoencoder, not only the encoding module of the residual autoencoder is required, but also encoding of an entropy encoding module is required, to generate the bitstream. Then, the bitstream needs to be processed by using decoding of the entropy decoding module and the decoding module of the residual autoencoder, to generate the reconstructed residual feature Rₜ. A specific process is as follows:

$${\hat{R}}_{t} = {f}_{decoder \_ R} ( Q ( {f}_{encoder \_ R} ( {R}_{t} ) ) ) \qquad ( 18 )$$

Herein, f_{encoder_R}(*), f_{decoder_R}(*) is the encoding module and the decoding module of the residual autoencoder, and Q(*) is a quantization process. It should be noted that a structure of the residual autoencoder is consistent with a structure of a motion parameter autoencoder. Therefore, structures of f_{encoder_R}(*), f_{decoder_R}(*) are respectively shown in FIG. 15 and FIG. 16. However, a person skilled in the art may learn that network structures of the encoding module and the decoding module of the residual autoencoder are not limited thereto.

Further, after the reconstructed residual feature is obtained, in some embodiments, the determining the reconstructed image feature based on the reconstructed residual feature and the target predicted image feature may include: performing an addition operation on the reconstructed residual feature and the target predicted image feature, to obtain the reconstructed image feature.

In a specific embodiment, the determining the reconstructed image feature based on the reconstructed residual feature and the target predicted image feature may include: performing an addition operation on the reconstructed residual feature and the target predicted image feature by using a fourth addition module, to obtain the reconstructed image feature. Herein, the reconstructed residual feature and the target predicted image feature are added by using the fourth addition module, to generate the reconstructed image feature. For the encoding end, the fourth addition module in embodiments of this application may be the adder 109 in FIG. 1.

Further, the reconstructed image of the current image may be reconstructed according to the reconstructed image feature. In some embodiments, the performing the feature enhancement and the reconstruction processing on the reconstructed image feature, to determine the reconstructed image of the current image may include: performing the feature enhancement and the reconstruction processing on the reconstructed image feature by using a reconstruction and enhancement module, to determine the reconstructed image of the current image.

It should be further noted that, in embodiments of this application, the reconstruction and enhancement module is a network structure used to implement feature enhancement and reconstruction, and may also be referred to as an “enhancement and reconstruction network”. The reconstruction and enhancement module includes at least one residual module, a fifth addition module, and a deconvolutional module. Correspondingly, in some embodiments, the performing the feature enhancement and the reconstruction processing on the reconstructed image feature by using the reconstruction and enhancement module, to determine the reconstructed image of the current image may include:
performing feature extraction on the reconstructed image feature by using the at least one residual module, to obtain a sixth intermediate feature;
performing an addition operation on the sixth intermediate feature and the reconstructed image feature by using the fifth addition module, to obtain a seventh intermediate feature; and
performing a deconvolution operation on the seventh intermediate feature by using the deconvolutional module, to obtain the reconstructed image of the current image.

It should be further noted that in embodiments of this application, the deconvolutional module may include a deconvolutional layer. An internal structure of the deconvolutional module and a specific quantity of deconvolutional layers are not limited herein. In addition, for the reconstruction and enhancement module, a quantity of residual modules may be 3, but may alternatively be another number. A specific quantity of residual modules is not limited herein.

Exemplarily, FIG. 11 shows an example of a structure of a reconstruction and enhancement module according to an embodiment of this application, but this application is not limited thereto. Herein, first, feature extraction is performed on a reconstructed image feature by using the three residual modules successively, to obtain a sixth intermediate feature. Then, the fifth addition module performs an addition operation on the sixth intermediate feature and the reconstructed image feature, to obtain a seventh intermediate feature. Finally, the deconvolutional module performs a deconvolution operation on the seventh intermediate feature, to obtain the reconstructed image of the current image.

In addition, in embodiments of this application, for the deconvolutional layer in the deconvolutional module, a quantity of channels may be set to 3, a size of a convolutional kernel may be 5×5, and a step may be set to 2. However, it should be noted that a convolution parameter (for example, a size of a convolutional kernel or a quantity of channels) of the deconvolutional layer is not fixed design, and may be adjusted herein. A specific value is not limited.

Further, in embodiments of this application, one bit (which is specifically first identification information) may be encoded in a bitstream, to indicate whether a predicted image feature enhancement mode is used for the current image. Therefore, in some embodiments, the method may further include:
determining a value of first identification information; and
encoding the value of the first identification information by using an encoding module of an autoencoder, and writing an obtained encoded bit into a bitstream.

It should be noted that, in embodiments of this application, the first identification information may be one predefined indicator bit to be written into the bitstream, and is used to indicate whether the predicted image feature enhancement mode is used for the current image. In this way, an encoding end may write the value of the first identification information into the bitstream. Subsequently, a decoding end may obtain the value of the first identification information through decoding, so that the decoding end can quickly determine whether to use the predicted image feature enhancement mode.

In some embodiments, the method may further include: if the first identification information indicates that the predicted image feature enhancement mode is used for the current image, executing the performing the enhancement processing on the initial predicted image feature according to the at least one reference image, to determine the target predicted image feature of the current image.

It should be further noted that, in embodiments of this application, if the first identification information indicates that the predicted image feature enhancement mode is used for the current image, the step of enhancement processing shown in FIG. 12 is executed, that is, the enhancement processing is performed on the initial predicted image feature according to the at least one reference image, to determine the target predicted image feature of the current image. Alternatively, if the first identification information indicates that the predicted image feature enhancement mode is not used for the current image, the step of enhancement processing shown in FIG. 12 is no longer executed. In this case, the obtained initial predicted image feature is directly used as the target predicted image feature of the current image.

In some embodiments, the determining the value of the first identification information may include:
if the first identification information indicates that the predicted image feature enhancement mode is used for the current image, determining that the value of the first identification information is a first value; or
if the first identification information indicates that the predicted image feature enhancement mode is not used for the current image, determining that the value of the first identification information is a second value.

In embodiments of this application, the first value is different from the second value, and the first value and the second value may be in a parameter form, or may be in a numeric form. Specifically, the first identification information may be a parameter written into a profile (profile), or may be a value of a flag (flag), which is not specifically limited herein.

Exemplarily, for the first value and the second value, the first value may be set to 1, and the second value may be set to 0. Alternatively, the first value may be set to 0, and the second value may be set to 1. Alternatively, the first value may be set to true, and the second value may be set to false. Alternatively, the first value may be set to false, and the second value may be set to true. However, this is not specifically limited herein.

In embodiments of this application, that the first identification information is a flag written into the bitstream is used as an example. If the first value is set to 1 and the second value is set to 0, when the value of the first identification information is 1, it may be determined that the predicted image feature enhancement mode is used for the current image. In this case, the enhancement processing needs to be performed on the initial predicted image feature according to the at least one reference image, to determine the target predicted image feature of the current image. Alternatively, when the value of the first identification information is 0, it may be determined that the predicted image feature enhancement mode is not used for the current image. In this case, the obtained initial predicted image feature is directly used as the target predicted image feature of the current image.

Further, in embodiments of this application, a preset network model may be trained by using a same training method as that in a related technology, that is, end-to-end training is performed on all modules of an entire video compression network. Therefore, in some embodiments, the method may further include:
determining a preset network model; and
performing end-to-end training on the preset network model, to determine a target network model, where the target network model is used to perform encoding, decoding and reconstruction operations on the current image.

The preset network model includes an initial network model and a prediction enhancement module, and the initial network model includes at least a feature extraction module, a motion parameter generation module, an autoencoder, a predicted feature generation module, and a reconstruction and enhancement module.

That is, in embodiments of this application, the prediction enhancement module may be embedded into an existing initial network model, and is configured to further enhance a predicted image feature after an initial predicted image feature is generated through motion compensation, to generate an enhanced target predicted image feature. Specifically, embodiments of this application provides a video encoding method based on end-to-end deep learning, that is, network models in embodiments of this application may be end-to-end trained together with the initial network model, so that a training method of the initial network model does not need to be changed, thereby greatly simplifying a training process of the video compression network. In addition, the autoencoder herein may include a motion parameter autoencoder and a residual autoencoder.

It may be learned from the above that in embodiments of this application, the following technical problems are mainly resolved herein. On the one hand, in a conventional process of generating a predicted image feature, a motion vector representation (offset) in motion estimation needs to be used, and the motion vector representation (offset) needs to be compressed and transmitted to a decoding end. This process is lossy. Therefore, a reconstructed motion vector representation (offset) is distorted, and correspondingly a generated predicted image feature is distorted. In embodiments of this application, a reconstructed image at a past instant is used to enhance the predicted image feature, thereby improving quality of a predicted image and reducing distortion of the predicted image. On the other hand, a predicted image of a current image cannot be well generated by using a single reference image, for example, due to an occluded region caused by motion. However, the occluded region may be included in a previous image. Therefore, embodiments of this application propose to enhance the predicted image by using a reconstructed image at a past instant. In conclusion, embodiments of this application can effectively improve quality of a predicted image feature.

Exemplarily, after the prediction enhancement technology in embodiments of this application is embedded into the FVC solution, encoding and decoding efficiency can be effectively improved. A test result is shown in Table 1. It may be learned from Table 1 that, compared with the FVC solution, an average Bjøntegaard delta bit rate (BDBR) in embodiments of this application is about 3.73%.

It should be further noted that, in embodiments of this application, the prediction enhancement technology herein may be applied not only to the FVC solution but also to the DCVC solution, and may even be applied to another video encoding network solution, which is not limited herein.

Further, an embodiment of this application provides a bitstream. The bitstream is generated by performing bit encoding according to to-be-encoded information, where the to-be-encoded information includes at least one of the following: a first motion parameter of a current image, a residual image feature of a current image, or a value of first identification information of a current image, where the first identification information is used to indicate whether a predicted image feature enhancement mode is used for the current image.

In embodiments of this application, for the first identification information, the predicted image feature enhancement mode may be added to the FVC solution or another encoding and decoding network solution, that is, encoding one bit to indicate whether to use the predicted image feature enhancement mode. When this mode is used, the encoding method or the decoding method in embodiments of this application may be used.

In this way, after writing the to-be-encoded information into the bitstream, an encoding end transmits the to-be-encoded information to a decoding end by using the bitstream. In this way, at the decoding end, whether the predicted image feature enhancement mode is used for the current image may be determined by decoding the bitstream, and the first motion parameter of the current image and the residual image feature may be determined by decoding the bitstream, to restore a reconstructed image of the current image.

This embodiment provides an encoding method. First, a reconstructed motion parameter of a current image is determined. Then, an initial predicted image feature of the current image is determined based on the reconstructed motion parameter. Then, enhancement processing is performed on the initial predicted image feature according to at least one reference image, to determine a target predicted image feature of the current image, where the target predicted image feature is used to determine a residual image feature of the current image. In this way, at an encoding end, a predicted image at a current instant is enhanced by using a reconstructed image at a past instant, thereby improving quality of the predicted image. This process includes: separately using the reconstructed images at the past instants to correct the predicted image at the current instant, and then fusing predicted images corrected by multiple images with the predicted image at the current instant, to generate a predicted image with higher quality. Therefore, according to the high-quality predicted image, quality of the reconstructed image of the current image can be improved, encoding and decoding efficiency can be improved, and video encoding and decoding performance can be improved.

In still another embodiment of this application, based on the decoding method and the encoding method described in the foregoing embodiments, embodiments of this application provide a network architecture of a video encoding and decoding system including a decoding method and an encoding method. FIG. 17 is a schematic diagram of a network architecture of video encoding and decoding according to an embodiment of this application. As shown in FIG. 17, the network architecture includes one or more electronic devices 13 to IN and a communications network 01, where the electronic devices 13 to IN may perform video interaction by using the communications network 01. In an implementation process, the electronic device may be various types of devices that have a video encoding and decoding function. For example, the electronic devices may include a mobile phone, a tablet computer, a personal computer, a personal digital assistant, a navigator, a digital telephone, a video telephone, a television set, a sensing device, and a server. This is not limited in embodiments of this application. A decoder or an encoder in embodiments of this application may be the foregoing electronic device.

The electronic devices in embodiments of this application have a video encoding and decoding function, and generally include a video encoder (that is, an encoder) and a video decoder (that is, a decoder).

It may be understood that, based on the decoding method and the encoding method described in the foregoing embodiments, an embodiment of this application provides a method for generating a predicted image feature enhanced based on multiple images. This method is embedded in a video encoding loop. Both an encoding end and a decoding end relate to this method. Specifically, a predicted image generated in a conventional manner of motion compensation is enhanced based on reconstructed images at a plurality of past instants, thereby improving quality of the predicted image and improving encoding efficiency.

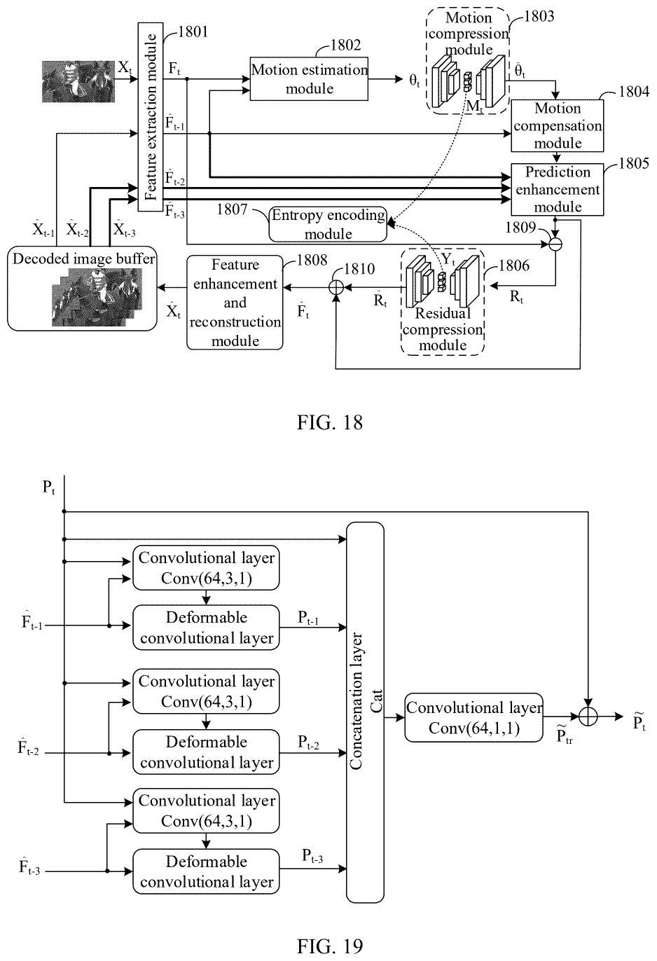

In a specific embodiment, at an encoding end, FIG. 18 is a schematic diagram of a detailed framework of an encoder according to an embodiment of this application. As shown in FIG. 18, the framework mainly includes a feature extraction module 1801, a motion estimation module 1802, a motion compression module 1803, a motion compensation module 1804, a prediction enhancement module 1805, a residual compression module 1806, an entropy encoding module 1807, a feature enhancement and reconstruction module 1808, a subtractor 1809, and an adder 1810. Three frames of reference images are used as an example. The prediction enhancement module 1805 herein may perform, according to respective reference image features (\hat{F}ₜ₋₁, \hat{F}ₜ₋₂, and \hat{F}ₜ₋₃) of the three frames of reference images, enhancement processing on an initial predicted image feature output by the motion compensation module 1804.

In FIG. 18, after the initial predicted image feature is generated through conventional motion compensation, multi-image enhancement is performed on the initial predicted image feature by using the reference image features, to improve quality of the initial predicted image feature. An enhancement effect is as follows. On the one hand, due to lossy compression of a motion vector representation, a predicted image generated by using the motion vector representation is distorted, and quality of the predicted image may be enhanced by using a reconstructed image. On the other hand, a predicted image of a current image cannot be well generated by using a single reference image, for example, due to an occluded region caused by motion. However, the occluded region may be included in a previous image, and after motion compensation is performed, the predicted image includes information about the current image. Therefore, a predicted image feature may be enhanced by using a reconstructed reference image, to improve quality of the predicted image feature.

In embodiments of this application, the foregoing modules are described in detail.

(1) Feature extraction module: Perform feature extraction on the current image and the reconstructed reference image (the three frames of reference images are used as an example, where the reference image features are respectively \hat{F}ₜ₋₁, \hat{F}ₜ₋₂, and \hat{F}ₜ₋₃, and a current image feature is Fₜ). An extraction process is specifically as follows:

$${F}_{t} = {f}_{feat} ( {X}_{t} ) ; {\hat{F}}_{t - 1} = {f}_{feat} ( {\hat{X}}_{t - 1} ) ;$$

$${\hat{F}}_{t - 2} = {f}_{feat} ( {\hat{X}}_{t - 2} ) ; {\hat{F}}_{t - 3} = {f}_{feat} ( {\hat{X}}_{t - 3} ) .$$

Herein, f_{feat}(*) is the feature extraction module, which is a same module, that is, a shared feature extraction module, for both the current image and the reconstructed reference image. The feature extraction module may include one convolutional layer and three layers of convolutional blocks based on a residual structure. A specific structure is shown in FIG. 6.

(2) Motion estimation module and motion compensation module: Generate the initial predicted image feature.

a) Deformable convolution is performed on a feature obtained by concatenating the current image feature Fₜ and the reference image feature \hat{F}ₜ₋₁, to generate a motion vector representation-offset θₜ (that is, a first motion parameter). A generation process is specifically as follows:

$${θ}_{t} = {f}_{o f fset} ( cat ( {F}_{t} , {\hat{F}}_{t - 1} ) ) .$$

Herein, cat(*) is a concatenation operation, and f_{offset}(*) is an offset generation network, which is a two-layer convolutional network. A specific structure is shown in FIG. 14.

b) Then, the first motion parameter et is encoded based on an encoding part of an autoencoder and entropy encoding, to generate a bitstream, and the bitstream is decoded based on entropy decoding and a decoding part of the autoencoder, to generate a reconstructed motion parameter \hat{θ}ₜ, which is shown as follows:

$${\hat{θ}}_{t} = {f}_{d e c o d e r} ( Q ( {f}_{e n c o d e r} ( {θ}_{t} ) ) ) .$$

Herein, f_{encoder}(*), f_{decoder}(*) is an encoding part and a decoding part of a motion parameter autoencoder, whose specific structures are respectively shown in FIG. 15 and FIG. 16, and Q(*) is a quantization process.

c) Then, the initial predicted image feature Pₜ (that is, motion compensation) is generated through deformable convolution and by using the reference image feature \hat{F}ₜ₋₁, which is shown as follows:

$${P}_{t} = {f}_{e n {c}_{p r e}} ( Dconv ( {\hat{F}}_{t - 1} , {\hat{θ}}_{t} ) ) .$$

Herein, Dconv(*) is deformable convolution, and f_{enc}_{ₚᵣₑ} is a two-layer convolutional network for feature enhancement. Finally, a predicted image feature is generated. A specific structure is shown in FIG. 9.

(3) Prediction enhancement module: A method for generating a predicted image feature enhanced based on a plurality of reconstructed reference images is a key part of embodiments of this application. The three frames of reference images are used as an example. A specific procedure is shown in FIG. 19. Feature extraction is performed on previously reconstructed reference images (the three images are used as an example, where the three images are respectively \hat{F}ₜ₋₁, \hat{F}ₜ₋₂, and \hat{F}ₜ₋₃), the reference image features are separately concatenated with the initial predicted image feature Pₜ generated through motion compensation, to generate offsets for deformable convolution, and the reference image features are processed through deformable convolution, to respectively generate compensation features. Then, after being processed by convolutional fusion, the compensation features are added to the initial predicted image feature Pₜ, to generate a final target predicted image feature \tilde{P}ₜ, that is, a current predicted image feature is corrected by using the compensation features.

Specific steps are as follows (the three images are used as an example, but a plurality of images may alternatively be used herein).

a) The reference image features, which are respectively \hat{F}ₜ₋₁, \hat{F}ₜ₋₂, and \hat{F}ₜ₋₃, may be extracted from the previously reconstructed reference images (\hat{X}ₜ₋₁, \hat{X}ₜ₋₂, and \hat{X}ₜ₋₃) by using the feature extraction module.

b) The three reference image features are separately concatenated with the initial predicted image feature (generated through motion compensation, that is, by using the method for generating a predicted image feature in the FVC solution). Then, an offset between a reconstructed image and a predicted image is generated by using two convolutional layers and a corresponding activation function, which is similar to a motion vector in conventional video encoding and decoding. Exemplarily, a quantity of channels is set to 64, a size of a convolutional kernel is 3×3, and a step is 1, which, however, is not limited thereto. A specific process is as follows:

$${o}_{t - n} = c o n v ( r e l u ( c o n v ( c a t ( {\hat{F}}_{t - n} , {P}_{t} ) ) ) ) , where n = \{ 1 , 2 , 3 \} .$$

c) After the offsets are obtained, correction features (that is, compensation features) are respectively generated from the previously reconstructed reference image features through deformable convolution. A specific process is as follows:

$${P}_{t - n} = D c o n v ( {\hat{F}}_{t - n} , {o}_{t - n} ) , where n = \{ 1 , 2 , 3 \} .$$

d) The generated plurality of correction features are concatenated with the initial predicted image feature and fused by using one convolutional layer, to finally generate a fused correction feature Pₜᵣ of the current predicted image. A specific process is as follows:

$${\tilde{P}}_{tr} = c o n v ( c a t ( {P}_{t} , {P}_{t - 1} , {P}_{t - 2} , {P}_{t - 3} ) .$$

e) The fused correction feature is added to the predicted image feature by using a residual structure, to generate the final target predicted image feature Pₜ. A specific process is as follows:

$${\tilde{P}}_{t} = {\tilde{P}}_{tr} + {P}_{t} .$$

(4) Feature enhancement and reconstruction module: First, subtraction is performed on the current image feature and the target predicted image feature, to obtain a residual image feature Rₜ=Fₜ-\tilde{P}ₜ. Further, the residual image feature is processed by an autoencoder, to generate a bitstream to be transmitted to a decoding end, and output a reconstructed residual feature Rₜ. Then, the reconstructed residual feature is added to the target predicted image feature, to generate \hat{F}ₜ=\hat{F}ₜ₋₁+\tilde{P}ₜ. At last, a final reconstructed image \hat{X}ₜ is generated through feature enhancement and reconstruction.

Specific steps are as follows.

a) When the residual image feature is processed by the autoencoder, a specific process is as follows:

$${\hat{R}}_{t} = {f}_{decoder \_ R} ( Q ( {f}_{encoder \_ R} ( {R}_{t} ) ) ) .$$

Herein, f_{encoder_R}(*), f_{decoder_R}(*) is an encoding part and a decoding part of a residual autoencoder, whose structures are consistent with those of an encoding part and a decoding part of a motion parameter autoencoder and may be specifically shown in FIG. 15 and FIG. 16. Q(*) is a quantization process.

b) The final reconstructed image is generated through feature enhancement and reconstruction. A specific process is as follows:

$${\hat{X}}_{t} = {f}_{enh \_ x} ( {\hat{F}}_{t} ) .$$

Herein, f_{enh_x}(*) is an enhancement and reconstruction network, which uses a plurality of layers of convolutional blocks based on a residual structure. A specific structure may be as shown in FIG. 11.

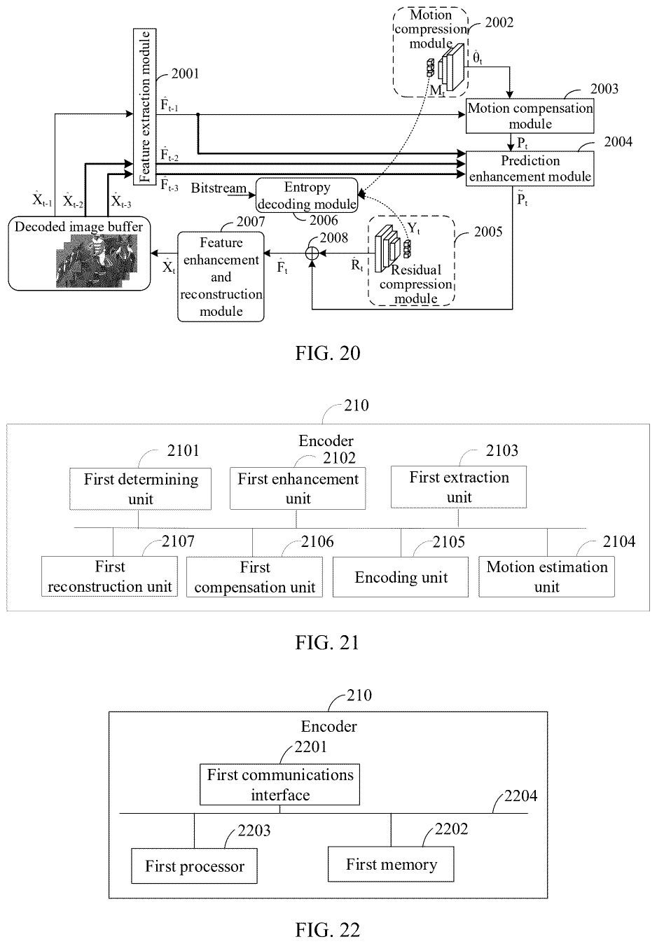

In another specific embodiment, at a decoding end, FIG. 20 is a schematic diagram of a detailed framework of a decoder according to an embodiment of this application. As shown in FIG. 20, the framework mainly includes a feature extraction module 2001, a motion compression module 2002, a motion compensation module 2003, a prediction enhancement module 2004, a residual compression module 2005, an entropy decoding module 2006, a feature enhancement and reconstruction module 2007, and an adder 2008. Three frames of reference images are still used as an example. The prediction enhancement module 2004 herein may also be configured to implement a function of the foregoing prediction enhancement module, that is, performing, according to respective reference image features (\hat{F}ₜ₋₁, \hat{F}ₜ₋₂, and \hat{F}ₜ₋₃) of the three frames of reference images, enhancement processing on an initial predicted image feature output by the motion compensation module 2003.

In FIG. 20, for the decoding end, after a bitstream of a motion parameter and a bitstream of a residual image feature are obtained, entropy decoding may be separately performed on the bitstreams, to obtain corresponding decoding features, that is, Mₜ and Yₜ. Then, the decoding features are processed by a decoding part of an autoencoder, to respectively obtain a reconstructed motion parameter θₜ and a reconstructed residual feature \hat{R}ₜ. Then, the reconstructed motion parameter and the reference images (decoded images) are used to generate an initial predicted image feature Pₜ. Then, enhancement processing is performed on the initial predicted image feature by using the plurality of reference image features, to generate a target predicted image feature \tilde{P}ₜ. Finally, the target predicted image feature is added to the reconstructed residual feature \hat{R}ₜ, and feature enhancement and reconstruction are performed to generate a reconstructed image \hat{X}ₜ.

In embodiments of this application, the foregoing modules are described in detail.

(1) Entropy decoding is performed on the bitstream of the motion parameter and the bitstream of the residual image feature, to obtain the corresponding decoding features, that is, Mₜ and Yₜ. Entropy encoding and entropy decoding may be performed by any entropy codec, and the process is lossless.

(2) The reconstructed motion parameter \hat{θ}ₜ is obtained after processing of a decoding part of a motion parameter autoencoder. A specific process is as follows:

$${\hat{θ}}_{t} = {f}_{d e c o d e r} ( {M}_{t} ) .$$

Herein, f_{decoder}(*) is the decoding part of the motion parameter autoencoder, which is a same network as a decoding part of a motion parameter autoencoder at an encoding end.

(3) The initial predicted image feature Pₜ is generated by using the reconstructed motion parameter et and the reference image feature \hat{F}ₜ₋₁. A specific process is as follows:

$${P}_{t} = {f}_{e n {c}_{p r e}} ( D c o n v ( {\hat{F}}_{t - 1} , {\hat{θ}}_{t} ) ) .$$

Herein, Dconv(*) is deformable convolution, and f_{enc}_{ₚᵣₑ}(*) is a two-layer convolutional network for feature enhancement, which finally generate the initial predicted image feature, and use a same network as the encoding end. A specific structure is as shown in FIG. 9.

(4) Enhancement processing is performed by using a same method as that of the encoding end, to generate the final target predicted image feature \tilde{P}ₜ.

(5) Yₜ is converted into the reconstructed residual feature \hat{R}ₜ by using a decoding part of a residual autoencoder. A specific process is as follows:

$${\hat{R}}_{t} = {f}_{decoder \_ R} ( {Y}_{t} ) .$$

Herein, f_{decoder_R}(*) is the decoding part of the residual autoencoder, which is a same network as a decoding part of a residual autoencoder at the encoding end.

(6) The target predicted image feature \tilde{P}ₜ is added to the reconstructed residual feature \hat{R}ₜ, and then feature enhancement and reconstruction are performed, to generate the reconstructed image \hat{X}ₜ. A specific process is as follows:

$${\hat{X}}_{t} = {f}_{enh \_ x} ( {\hat{R}}_{t} + {\tilde{P}}_{t} ) .$$

Herein, f_{enh_x}(*) is an enhancement and reconstruction network, which uses a plurality of layers of convolutional blocks based on a residual structure and uses a same network as the encoding end. A specific structure is shown in FIG. 11.

It should be noted that due to a requirement for consistency between the encoding end and the decoding end, the encoding end generates a reconstructed image. Therefore, an entire decoding process exists at the encoding end. As a result, a network at the decoding end has a corresponding network at the encoding end, and the two networks are the same.

Further, in embodiments of this application, for a training process, in embodiments of this application, a prediction enhancement module may be embedded into a full-network video encoding method in a related technology, and is configured to further enhance a predicted image feature after a predicted image is generated through motion compensation, to generate an enhanced target predicted image feature. Therefore, the method in embodiments of this application may be used to perform end-to-end training together with the related technology, so that a training method in the related technology is not changed.

Further, in embodiments of this application, the final target predicted image feature may be directly generated without using a residual structure.

Further, in embodiments of this application, a process of using a reference image to correct a current predicted image through deformable convolution may be replaced by direct convolution, that is, the predicted image is directly fused with a previously reconstructed reference image feature, and a final target predicted image feature is generated through convolution.

Further, in embodiments of this application, an enhancement part herein may also be described as adding a predicted image feature enhancement mode into the FVC solution or another encoding and decoding network solution, that is, encoding one bit to represent the predicted image feature enhancement mode. When this mode is used, the encoding method or the decoding method in embodiments of this application is used.

Briefly, an embodiment of this application proposes a method for generating a predicted image enhanced based on multiple images. A predicted image at a current instant is enhanced by using reconstructed images at past instants, to improve quality of the predicted image. This process includes separately using the reconstructed images at the past instants to correct the predicted image at the current instant, and then fusing predicted images corrected by using the plurality of images with the predicted image at the current instant, to generate a predicted image with higher quality.

Exemplarily, after a prediction enhancement technology in embodiments of this application is embedded into the FVC solution, encoding and decoding efficiency can be effectively improved. Table 1 shows an improvement effect of the prediction enhancement technology in embodiments of this application relative to the FVC solution. Specifically, the improvement is a Bjøntegaard delta bit rate (Bjøntegaard Delta Bit Rate, BDBR). It may be learned from the test result in Table 1 that, compared with the FVC solution, an average Bjøntegaard delta bit rate (BDBR) of embodiments of this application is about 3.73%.

It should be further noted that, in embodiments of this application, the prediction enhancement technology herein may be applied not only to the FVC solution but also to the DCVC solution, and may even be applied to another video encoding network solution, which is not limited herein.

Specific implementations of the foregoing embodiments are described in detail. It may be learned that, according to the technical solutions of the foregoing embodiments, the following technical problems are mainly resolved herein. On the one hand, in a conventional process of generating a predicted image feature, a motion vector representation (offset) in motion estimation needs to be used, and the motion vector representation (offset) needs to be compressed and transmitted to a decoding end. This process is lossy. Therefore, a reconstructed motion vector representation (offset) is distorted, and correspondingly a generated predicted image feature is distorted. In embodiments of this application, a reconstructed image at a past instant may be used to enhance the predicted image feature, thereby improving quality of a predicted image and reducing distortion of the predicted image. On the other hand, a predicted image of a current image cannot be well generated by using a single reference image, for example, due to an occluded region caused by motion. However, the occluded region may be included in a previous image. Therefore, embodiments of this application propose to enhance quality of the predicted image by using a reconstructed image at a past instant. In this way, according to the high-quality predicted image, quality of a reconstructed image of the current image can be improved, encoding and decoding efficiency can be improved, and video encoding and decoding performance can be improved.

In still another embodiment of this application, based on a same invention concept as the foregoing embodiments, referring to FIG. 21, FIG. 21 is a schematic structural diagram of an encoder according to an embodiment of this application. As shown in FIG. 21, the encoder 210 may include a first determining unit 2101 and a first enhancement unit 2102.

The first determining unit 2101 is configured to: determine a reconstructed motion parameter of a current image; and determine an initial predicted image feature of the current image based on the reconstructed motion parameter.

The first enhancement unit 2102 is configured to: perform enhancement processing on the initial predicted image feature according to at least one reference image, to determine a target predicted image feature of the current image, where the target predicted image feature is used to determine a residual image feature of the current image.

In some embodiments, the first determining unit 2101 is further configured to: determine a first reference image; determine a first motion parameter based on the first reference image and the current image; and perform encoding and decoding processing on the first motion parameter, to determine the reconstructed motion parameter of the current image.

In some embodiments, referring to FIG. 21, the encoder 210 may further include a first extraction unit 2103 and a motion estimation unit 2104.

The first extraction unit 2103 is configured to separately perform feature extraction on the current image and the first reference image, to determine a current image feature and a first reference image feature.

The motion estimation unit 2104 is configured to perform motion estimation according to the first reference image feature and the current image feature, to determine the first motion parameter.

In some embodiments, the first extraction unit 2103 is further configured to: perform the feature extraction on the current image by using a feature extraction module, to obtain the current image feature; and perform the feature extraction on the first reference image by using the feature extraction module, to obtain the first reference image feature.

In some embodiments, the motion estimation unit 2104 is further configured to perform the motion estimation on the first reference image feature and the current image feature by using a motion parameter generation module, to determine the first motion parameter.

In some embodiments, the motion parameter generation module includes a third concatenation module and a sixth convolutional module. Correspondingly, the motion estimation unit 2104 is further configured to: perform a concatenation operation on the first reference image feature and the current image feature by using the third concatenation module, to obtain an eighth intermediate feature; and perform a convolution operation on the eighth intermediate feature by using the sixth convolutional module, to obtain the first motion parameter.

In some embodiments, referring to FIG. 21, the encoder 210 may further include an encoding unit 2105, configured to perform encoding and decoding processing on the first motion parameter by using an autoencoder, to determine the reconstructed motion parameter of the current image.

In some embodiments, the autoencoder includes an encoding module and a decoding module. Correspondingly, the encoding unit 2105 is further configured to: perform the encoding processing on the first motion parameter by using the encoding module of the autoencoder, and write an obtained encoded bit into a bitstream; and perform the decoding processing on the bitstream by using the decoding module of the autoencoder, to obtain the reconstructed motion parameter of the current image.

In some embodiments, referring to FIG. 21, the encoder 210 may further include a first compensation unit 2106.

The first determining unit 2101 is further configured to determine a first reference image.

The first extraction unit 2103 is further configured to perform feature extraction on the first reference image, to determine a first reference image feature.

The first compensation unit 2106 is configured to perform motion compensation according to the first reference image feature and the reconstructed motion parameter, to determine the initial predicted image feature.

In some embodiments, the first reference image is adjacent to the current image, and the first reference image is a reconstructed image of an image preceding to the current image by one frame.

In some embodiments, the first compensation unit 2106 is further configured to perform the motion compensation on the first reference image feature and the reconstructed motion parameter by using the predicted feature generation module, to determine the initial predicted image feature.

In some embodiments, the predicted feature generation module includes a fourth convolutional module, a second concatenation module, a fifth convolutional module, and a third addition module. Correspondingly, the first compensation unit 2106 is further configured to: perform a deformable convolution operation on the reconstructed motion parameter and the first reference image feature by using the fourth convolutional module, to obtain a third intermediate feature; perform a concatenation operation on the third intermediate feature and the first reference image feature by using the second concatenation module, to obtain a fourth intermediate feature; perform a convolution operation on the fourth intermediate feature by using the fifth convolutional module, to obtain a fifth intermediate feature; and perform an addition operation on the third intermediate feature and the fifth intermediate feature by using the third addition module, to obtain the initial predicted image feature.

In some embodiments, the fourth convolutional module includes a second deformable convolutional layer, the second concatenation module includes a second concatenation layer, and the fifth convolutional module includes a fifth convolutional layer.

In some embodiments, the first extraction unit 2103 is further configured to separately perform feature extraction on the at least one reference image, to determine at least one reference image feature.

The first enhancement unit 2102 is further configured to perform the enhancement processing on the initial predicted image feature according to the at least one reference image feature, to determine the target predicted image feature.

In some embodiments, the first extraction unit 2103 is further configured to separately perform the feature extraction on the at least one reference image by using the feature extraction module, to determine the at least one reference image feature.

In some embodiments, the at least one reference image includes a first reference image, a second reference image, and a third reference image. Correspondingly, the first extraction unit 2103 is further configured to: perform the feature extraction on the first reference image by using the feature extraction module, to obtain a first reference image feature; perform the feature extraction on the second reference image by using the feature extraction module, to obtain a second reference image feature; perform the feature extraction on the third reference image by using the feature extraction module, to obtain a third reference image feature; and determine the first reference image feature, the second reference image feature, and the third reference image feature as the at least one reference image feature.

In some embodiments, the first reference image is a reconstructed image of an image preceding to the current image by one frame; the second reference image is a reconstructed image of an image preceding to the current image by two frames; and the third reference image is a reconstructed image of an image preceding to the current image by three frames.

In some embodiments, the first enhancement unit 2102 is further configured to perform an enhancement operation on the at least one reference image feature and the initial predicted image feature by using a prediction enhancement module, to determine the target predicted image feature.

In some embodiments, the prediction enhancement module includes a first convolutional module, a first concatenation module, a second convolutional module, and a first addition module. Correspondingly, the first enhancement unit 2102 is further configured to: separately use the at least one reference image feature to perform a convolution operation with the initial predicted image feature by using the first convolutional module, to obtain at least one correction feature; perform a concatenation operation on the at least one correction feature and the initial predicted image feature by using the first concatenation module, to obtain a concatenated feature; perform convolutional fusion processing on the concatenated feature by using the second convolutional module, to obtain a fused correction feature; and perform an addition operation on the fused correction feature and the initial predicted image feature by using the first addition module, to obtain the target predicted image feature.

In some embodiments, the first convolutional module includes at least one convolutional submodule, and a quantity of the at least one convolutional submodule has a correspondence with a quantity of the at least one reference image.

In some embodiments, the convolutional submodule includes a first convolutional layer and a first deformable convolutional layer; the first concatenation module includes a first concatenation layer; and the second convolutional module includes a second convolutional layer.

In some embodiments, the convolutional submodule includes a first convolutional layer; the first concatenation module includes a first concatenation layer; and the second convolutional module includes a second convolutional layer.

In some embodiments, the feature extraction module includes a third convolutional module, at least one residual module, and a second addition module. Correspondingly, the first extraction unit 2103 is further configured to: perform feature extraction on the first reference image by using the third convolutional module, to obtain a first intermediate feature; perform feature extraction on the first intermediate feature by using the at least one residual module, to obtain a second intermediate feature; and perform an addition operation on the first intermediate feature and the second intermediate feature by using the second addition module, to obtain the first reference image feature.

In some embodiments, referring to FIG. 21, the encoder 210 may further include a first reconstruction unit 2107.

The first determining unit 2101 is further configured to determine a reconstructed residual feature of the current image; and determine a reconstructed image feature based on the reconstructed residual feature and the target predicted image feature.

The first reconstruction unit 2107 is configured to perform feature enhancement and reconstruction processing on the reconstructed image feature, to determine the reconstructed image of the current image.

In some embodiments, the first determining unit 2101 is further configured to determine a current image feature corresponding to the current image; and determine the residual image feature based on the current image feature and the target predicted image feature.

The encoding unit 2105 is further configured to perform encoding and decoding processing on the residual image feature, to determine the reconstructed residual feature of the current image.

In some embodiments, the first determining unit 2101 is further configured to perform a subtraction operation on the current image feature and the target predicted image feature by using a first subtraction module, to obtain the residual image feature.

In some embodiments, the encoding unit 2105 is further configured to: perform the encoding processing on the residual image feature by using an encoding module of an autoencoder, and write an obtained encoded bit into a bitstream; and perform the decoding processing on the bitstream by using a decoding module of the autoencoder, to obtain the reconstructed residual feature of the current image.

In some embodiments, the first determining unit 2101 is further configured to perform an addition operation on the reconstructed residual feature and the target predicted image feature by using a fourth addition module, to obtain the reconstructed image feature.

In some embodiments, the first reconstruction unit 2107 is further configured to perform the feature enhancement and the reconstruction processing on the reconstructed image feature by using a reconstruction and enhancement module, to determine the reconstructed image of the current image.

In some embodiments, the reconstruction and enhancement module includes at least one residual module, a fifth addition module, and a deconvolutional module. Correspondingly, the first reconstruction unit 2107 is further configured to: perform feature extraction on the reconstructed image feature by using the at least one residual module, to obtain a sixth intermediate feature; perform an addition operation on the sixth intermediate feature and the reconstructed image feature by using the fifth addition module, to obtain a seventh intermediate feature; and perform a deconvolution operation on the seventh intermediate feature by using the deconvolutional module, to obtain the reconstructed image of the current image.

In some embodiments, the first determining unit 2101 is further configured to determine a value of first identification information.

The encoding unit 2105 is further configured to encode the value of the first identification information by using an encoding module of an autoencoder, and write an obtained encoded bit into a bitstream, where the first identification information is used to indicate whether a predicted image feature enhancement mode is used for the current image.

In some embodiments, the first determining unit 2101 is further configured to: if the first identification information indicates that the predicted image feature enhancement mode is used for the current image, determine that the value of the first identification information is a first value; or if the first identification information indicates that the predicted image feature enhancement mode is not used for the current image, determine that the value of the first identification information is a second value.

In some embodiments, the first determining unit 2101 is further configured to: if the first identification information indicates that the predicted image feature enhancement mode is used for the current image, execute the performing the enhancement processing on the initial predicted image feature according to the at least one reference image, to determine the target predicted image feature of the current image.

In some embodiments, the first determining unit 2101 is further configured to: determine a preset network model; and perform end-to-end training on the preset network model, to determine a target network model, where the target network model is used to perform encoding, decoding and reconstruction operations on the current image, where the preset network model includes an initial network model and a prediction enhancement module, and the initial network model includes at least a feature extraction module, a motion parameter generation module, an autoencoder, a predicted feature generation module, and a reconstruction and enhancement module.

It may be understood that, in embodiments of this application, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor (processor) to execute all or some of the steps of the methods described in the embodiments. The foregoing storage medium includes various media that may store a program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to an encoder 210. The computer-readable storage medium stores a computer program, and the computer program is executed by a first processor to implement a method according to any one of the foregoing embodiments.

Based on the composition of the encoder 210 and the computer-readable storage medium, referring to FIG. 22, FIG. 22 is a schematic diagram of a structure of specific hardware of the encoder 210 according to an embodiment of this application. As shown in FIG. 22, the encoder 210 may include a first communications interface 2201, a first memory 2202, and a first processor 2203. The components are coupled together by using a first bus system 2204. It may be understood that the first bus system 2204 is configured to implement connection and communication between these components. The first bus system 2204 may further include a power bus, a control bus, a status signal bus, and the like in addition to a data bus. However, for clarity of description, various buses are all marked as the first bus system 2204 in FIG. 22.

The first communications interface 2201 is configured to receive and transmit signals in a process of transmitting and receiving information with other external network elements.

The first memory 2202 is configured to store a computer program runnable on the first processor 2203.

The first processor 2203 is configured to run the computer program to execute the following operations:
determining a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, where the target predicted image feature is used to determine a residual image feature of the current image.

It may be understood that, in embodiments of this application, the first memory 2202 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 2202 in the systems and the methods described in this application include but are not limited to these and any memory of another appropriate type.

However, the first processor 2203 may be an integrated circuit chip having a signal processing capability. In an implementation process, steps in the foregoing method may be implemented by using a hardware integrated logical circuit in the first processor 2203, or by using instructions in a form of software. The foregoing first processor 2203 may be a general-purpose processor, a digital signal processor (Digital Signal Processor, DSP), an application-specific integrated circuit (Application Specific Integrated Circuit, ASIC), a field-programmable gate array (Field Programmable Gate Array, FPGA) or another programmable logic device, a discrete gate or transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in the first memory 2202, and the first processor 2203 reads information in the first memory 2202 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, and other electronic units configured to execute the functions described in this application, or a combination thereof. For software implementation, the techniques described in this application may be implemented by modules (such as processes and functions) that execute the functions described in this application. Software code may be stored in a memory and executed by a processor. The memory may be implemented in the processor or outside the processor.

Optionally, in another embodiment, the first processor 2203 is further configured to run the computer program to execute a method according to any one of the foregoing embodiments.

This embodiment provides an encoder. For the encoder, after the initial predicted image feature of the current image is determined based on the reconstructed motion parameter, enhancement processing may be performed on the initial predicted image feature by using a reconstructed reference image, thereby improving quality of a predicted image and reducing distortion of the predicted image. In addition, for a reason such as an occluded region caused by motion, a predicted image cannot be well generated by using a single reference image. In this case, enhancement processing is performed on the initial predicted image feature by using at least one reconstructed reference image, which can further improve quality of the predicted image, thereby improving quality of the reconstructed image of the current image and improving encoding and decoding efficiency.

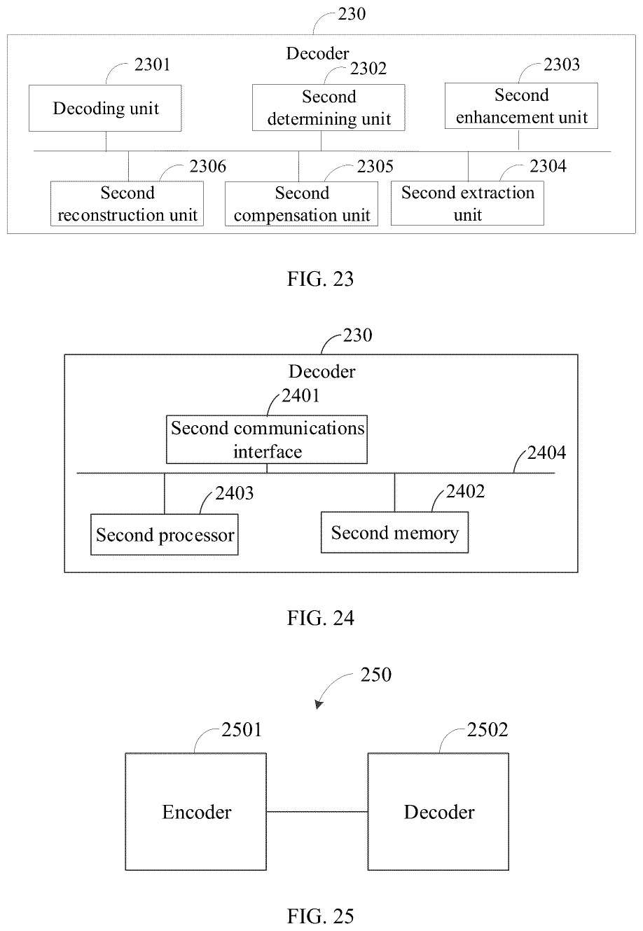

In another embodiment of this application, based on a same invention concept as the foregoing embodiments, FIG. 23 is a schematic structural diagram of a decoder according to embodiments of this application. As shown in FIG. 23, the decoder 230 may include a decoding unit 2301, a second determining unit 2302, and a second enhancement unit 2303.

The decoding unit 2301 is configured to decode a bitstream, to determine a reconstructed motion parameter of a current image.

The second determining unit 2302 is configured to determine an initial predicted image feature of the current image based on the reconstructed motion parameter.

The second enhancement unit 2303 is configured to: perform enhancement processing on the initial predicted image feature according to at least one reference image, to determine a target predicted image feature of the current image, where the target predicted image feature is used to determine a reconstructed image of the current image.

In some embodiments, referring to FIG. 23, the decoder 230 may further include a second extraction unit 2304, configured to separately perform feature extraction on the at least one reference image, to determine at least one reference image feature.

The second enhancement unit 2303 is further configured to perform the enhancement processing on the initial predicted image feature according to the at least one reference image feature, to determine the target predicted image feature.

In some embodiments, the second extraction unit 2304 is further configured to separately perform the feature extraction on the at least one reference image by using the feature extraction module, to determine the at least one reference image feature.

In some embodiments, the at least one reference image includes a first reference image, a second reference image, and a third reference image. Correspondingly, the second extraction unit 2304 is further configured to: perform the feature extraction on the first reference image by using the feature extraction module, to obtain a first reference image feature; perform the feature extraction on the second reference image by using the feature extraction module, to obtain a second reference image feature; perform the feature extraction on the third reference image by using the feature extraction module, to obtain a third reference image feature; and determine the first reference image feature, the second reference image feature, and the third reference image feature as the at least one reference image feature.

In some embodiments, the first reference image is a reconstructed image of an image preceding to the current image by one frame; the second reference image is a reconstructed image of an image preceding to the current image by two frames; and the third reference image is a reconstructed image of an image preceding to the current image by three frames.

In some embodiments, the second enhancement unit 2303 is further configured to perform an enhancement operation on the at least one reference image feature and the initial predicted image feature by using a prediction enhancement module, to determine the target predicted image feature.

In some embodiments, the prediction enhancement module includes a first convolutional module, a first concatenation module, a second convolutional module, and a first addition module. Correspondingly, the second enhancement unit 2303 is further configured to: separately use the at least one reference image feature to perform a convolution operation with the initial predicted image feature by using the first convolutional module, to obtain at least one correction feature; perform a concatenation operation on the at least one correction feature and the initial predicted image feature by using the first concatenation module, to obtain a concatenated feature; perform convolutional fusion processing on the concatenated feature by using the second convolutional module, to obtain a fused correction feature; and perform an addition operation on the fused correction feature and the initial predicted image feature by using the first addition module, to obtain the target predicted image feature.

In some embodiments, the first convolutional module includes at least one convolutional submodule, and a quantity of the at least one convolutional submodule has a correspondence with a quantity of the at least one reference image.

In some embodiments, the convolutional submodule includes a first convolutional layer and a first deformable convolutional layer; the first concatenation module includes a first concatenation layer; and the second convolutional module includes a second convolutional layer.

In some embodiments, the convolutional submodule includes a first convolutional layer; the first concatenation module includes a first concatenation layer; and the second convolutional module includes a second convolutional layer.

In some embodiments, the feature extraction module includes a third convolutional module, at least one residual module, and a second addition module. Correspondingly, the second extraction unit 2304 is further configured to: perform feature extraction on the first reference image by using the third convolutional module, to obtain a first intermediate feature; perform feature extraction on the first intermediate feature by using the at least one residual module, to obtain a second intermediate feature; and perform an addition operation on the first intermediate feature and the second intermediate feature by using the second addition module, to obtain the first reference image feature.

In some embodiments, referring to FIG. 23, the decoder may further include a second compensation unit 2305.

The second determining unit 2302 is further configured to determine a first reference image.

The second extraction unit 2304 is further configured to perform feature extraction on the first reference image, to determine a first reference image feature.

The second compensation unit 2305 is configured to perform motion compensation according to the first reference image feature and the reconstructed motion parameter, to determine the initial predicted image feature.

In some embodiments, the first reference image is adjacent to the current image, and the first reference image is a reconstructed image of an image preceding to the current image by one frame.

In some embodiments, the second compensation unit 2305 is further configured to perform the motion compensation on the first reference image feature and the reconstructed motion parameter by using the predicted feature generation module, to determine the initial predicted image feature.

In some embodiments, the predicted feature generation module includes a fourth convolutional module, a second concatenation module, a fifth convolutional module, and a third addition module. Correspondingly, the second compensation unit 2305 is further configured to: perform a deformable convolution operation on the reconstructed motion parameter and the first reference image feature by using the fourth convolutional module, to obtain a third intermediate feature; perform a concatenation operation on the third intermediate feature and the first reference image feature by using the second concatenation module, to obtain a fourth intermediate feature; perform a convolution operation on the fourth intermediate feature by using the fifth convolutional module, to obtain a fifth intermediate feature; and perform an addition operation on the third intermediate feature and the fifth intermediate feature by using the third addition module, to obtain the initial predicted image feature.

In some embodiments, the fourth convolutional module includes a second deformable convolutional layer, the second concatenation module includes a second concatenation layer, and the fifth convolutional module includes a fifth convolutional layer.

In some embodiments, referring to FIG. 23, the decoder may further include a second reconstruction unit 2306.

The decoding unit 2301 is further configured to decode a bitstream, to determine a reconstructed residual feature of a current image.

The second determining unit 2302 is further configured to determine a reconstructed image feature based on the reconstructed residual feature and the target predicted image feature.

The second reconstruction unit 2306 is configured to perform feature enhancement and reconstruction processing on the reconstructed image feature, to determine the reconstructed image of the current image.

In some embodiments, the second determining unit 2302 is further configured to perform an addition operation on the reconstructed residual feature and the target predicted image feature by using a fourth addition module, to obtain the reconstructed image feature.

In some embodiments, the second reconstruction unit 2306 is further configured to perform the feature enhancement and the reconstruction processing on the reconstructed image feature by using a reconstruction and enhancement module, to determine the reconstructed image of the current image.

In some embodiments, the reconstruction and enhancement module includes at least one residual module, a fifth addition module, and a deconvolutional module. Correspondingly, the second reconstruction unit 2306 is further configured to: perform feature extraction on the reconstructed image feature by using the at least one residual module, to obtain a sixth intermediate feature; perform an addition operation on the sixth intermediate feature and the reconstructed image feature by using the fifth addition module, to obtain a seventh intermediate feature; and perform a deconvolution operation on the seventh intermediate feature by using the deconvolutional module, to obtain the reconstructed image of the current image.

In some embodiments, the decoding unit 2301 is configured to decode a bitstream, to determine a value of first identification information.

The second determining unit 2302 is further configured to: if the first identification information indicates that the predicted image feature enhancement mode is used for the current image, execute the performing the enhancement processing on the initial predicted image feature according to the at least one reference image, to determine the target predicted image feature of the current image.

In some embodiments, the second determining unit 2302 is further configured to: if the value of the first identification information is a first value, determine that the first identification information indicates that the predicted image feature enhancement mode is used for the current image; or if the value of the first identification information is a second value, determine that the first identification information indicates that the predicted image feature enhancement mode is not used for the current image.

In some embodiments, the second determining unit 2302 is further configured to: determine a preset network model; and perform end-to-end training on the preset network model, to determine a target network model, where the target network model is used to perform encoding, decoding and reconstruction operations on the current image, where the preset network model includes an initial network model and a prediction enhancement module, and the initial network model includes at least a feature extraction module, a motion parameter generation module, an autoencoder, a predicted feature generation module, and a reconstruction and enhancement module.

It may be understood that in embodiments, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment provides a computer-readable storage medium, applied to a decoder 230. The computer-readable storage medium stores a computer program, and the computer program is executed by a second processor to implement the method according to any one of the foregoing embodiments.

Based on the composition of the decoder 230 and the computer-readable storage medium, referring to FIG. 24, FIG. 24 is a schematic diagram of a specific hardware structure of the decoder 230 according to an embodiment of this application. As shown in FIG. 24, the decoder 230 may include a second communications interface 2401, a second memory 2402, and a second processor 2403. The components are coupled together through a second bus system 2404. It may be understood that the second bus system 2404 is configured to implement connection and communication between these components. The second bus system 2404 may further include a power bus, a control bus, a status signal bus, and the like, in addition to a data bus. However, for clarity of description, various buses are all marked as the second bus system 2404 in FIG. 24.

The second communications interface 2401 is configured to receive and transmit a signal in a process of transmitting and receiving information between the second communications interface and another external network element.

The second memory 2402 is configured to store a computer program runnable on the second processor 2403.

The second processor 2403 is configured to run the computer program to execute the following operations:
decoding a bitstream, to determine a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, where the target predicted image feature is used to determine a reconstructed image of the current image.

Optionally, in another embodiment, the second processor 2403 is further configured to run the computer program to execute a method according to any one of the foregoing embodiments.

It may be understood that hardware functions of the second memory 2402 are similar to those of the first memory 2202, and hardware functions of the second processor 2403 are similar to those of the first processor 2203. This is not detailed here.

This embodiment provides a decoder. For the decoder, after the initial predicted image feature of the current image is determined based on the reconstructed motion parameter, enhancement processing may be performed on the initial predicted image feature by using a reconstructed reference image, thereby improving quality of a predicted image and reducing distortion of the predicted image. In addition, for a reason such as an occluded region caused by motion, a predicted image cannot be well generated by using a single reference image. In this case, enhancement processing is performed on the initial predicted image feature by using at least one reconstructed reference image, which can further improve quality of the predicted image, thereby improving quality of the reconstructed image of the current image and improving encoding and decoding efficiency.

In another embodiment of this application, FIG. 25 is a schematic structural diagram of an encoding and decoding system according to embodiments of this application. As shown in FIG. 25, the encoding and decoding system 250 may include an encoder 2501 and a decoder 2502. The encoder 2501 may be the encoder according to any one of the foregoing embodiments, and the decoder 2502 may be the decoder according to any one of the foregoing embodiments.

It should be noted that in this application, the term “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a . . . ” does not exclude the existence of other identical elements in the process, method, item or device including this element.

The foregoing sequence numbers of embodiments of this application are merely described, and do not represent advantages or disadvantages of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### Industrial Practicality

In embodiments of this application, at both an encoding end and a decoding end, after a reconstructed motion parameter of a current image is determined, an initial predicted image feature of the current image is determined based on the reconstructed motion parameter. Then, enhancement processing is performed on the initial predicted image feature according to at least one reference image, to determine a target predicted image feature of the current image. At the encoding end, the target predicted image feature is used to determine a residual image feature of the current image. Then, the residual image feature is transmitted to the decoding end by using a bitstream, so that the decoding end can determine a reconstructed image of the current image based on the residual image feature and the target predicted image feature. In this way, after the initial predicted image feature of the current image is determined based on the reconstructed motion parameter, enhancement processing may be performed on the initial predicted image feature by using a reconstructed reference image, thereby improving quality of a predicted image and reducing distortion of the predicted image. In addition, for a reason such as an occluded region caused by motion, a predicted image cannot be well generated by using a single reference image. In this case, enhancement processing is performed on the initial predicted image feature by using at least one reconstructed reference image, which can further improve quality of the predicted image, thereby improving quality of the reconstructed image of the current image and improving encoding and decoding efficiency.

What is claimed is:

1. A decoding method, applied to a decoder, wherein the method comprises:
decoding a bitstream, to determine a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, wherein the target predicted image feature is used to determine a reconstructed image of the current image.

2. The method according to claim 1, wherein the performing the enhancement processing on the initial predicted image feature according to the at least one reference image, to determine the target predicted image feature of the current image comprises:
separately performing feature extraction on the at least one reference image, to determine at least one reference image feature; and
performing the enhancement processing on the initial predicted image feature according to the at least one reference image feature, to determine the target predicted image feature.

3. The method according to claim 2, wherein the separately performing the feature extraction on the at least one reference image, to determine the at least one reference image feature comprises:
separately performing the feature extraction on the at least one reference image by using a feature extraction module, to determine the at least one reference image feature.

4. The method according to claim 3, wherein the at least one reference image comprises a first reference image, a second reference image, and a third reference image; and
the separately performing the feature extraction on the at least one reference image by using the feature extraction module, to determine the at least one reference image feature comprises:
performing the feature extraction on the first reference image by using the feature extraction module, to obtain a first reference image feature;
performing the feature extraction on the second reference image by using the feature extraction module, to obtain a second reference image feature;
performing the feature extraction on the third reference image by using the feature extraction module, to obtain a third reference image feature; and
determining the first reference image feature, the second reference image feature, and the third reference image feature as the at least one reference image feature.

5. The method according to claim 4, wherein
the first reference image is a reconstructed image of an image preceding to the current image by one frame;
the second reference image is a reconstructed image of an image preceding to the current image by two frames; and
the third reference image is a reconstructed image of an image preceding to the current image by three frames.

6. The method according to claim 2, wherein the performing the enhancement processing on the initial predicted image feature according to the at least one reference image feature, to determine the target predicted image feature comprises:
performing an enhancement operation on the at least one reference image feature and the initial predicted image feature by using a prediction enhancement module, to determine the target predicted image feature.

7. The method according to claim 6, wherein the prediction enhancement module comprises a first convolutional module, a first concatenation module, a second convolutional module, and a first addition module; and
the performing the enhancement operation on the at least one reference image feature and the initial predicted image feature by using the prediction enhancement module, to determine the target predicted image feature comprises:
separately using the at least one reference image feature to perform a convolution operation with the initial predicted image feature by using the first convolutional module, to obtain at least one correction feature;
performing a concatenation operation on the at least one correction feature and the initial predicted image feature by using the first concatenation module, to obtain a concatenated feature;
performing convolutional fusion processing on the concatenated feature by using the second convolutional module, to obtain a fused correction feature; and
performing an addition operation on the fused correction feature and the initial predicted image feature by using the first addition module, to obtain the target predicted image feature.

8. The method according to claim 7, wherein the first convolutional module comprises at least one convolutional submodule, and a quantity of the at least one convolutional submodule has a correspondence with a quantity of the at least one reference image.

9. The method according to claim 8, wherein
the convolutional submodule comprises a first convolutional layer and a first deformable convolutional layer;
the first concatenation module comprises a first concatenation layer; and
the second convolutional module comprises a second convolutional layer.

10. The method according to claim 8, wherein
the convolutional submodule comprises a first convolutional layer;
the first concatenation module comprises a first concatenation layer; and
the second convolutional module comprises a second convolutional layer.

11. The method according to claim 4, wherein the feature extraction module comprises a third convolutional module, at least one residual module, and a second addition module; and
the performing the feature extraction on the first reference image by using the feature extraction module, to obtain the first reference image feature comprises:
performing feature extraction on the first reference image by using the third convolutional module, to obtain a first intermediate feature;
performing feature extraction on the first intermediate feature by using the at least one residual module, to obtain a second intermediate feature; and
performing an addition operation on the first intermediate feature and the second intermediate feature by using the second addition module, to obtain the first reference image feature.

12. The method according to claim 1, wherein the determining the initial predicted image feature of the current image based on the reconstructed motion parameter comprises:
determining a first reference image;
performing feature extraction on the first reference image, to determine a first reference image feature; and
performing motion compensation according to the first reference image feature and the reconstructed motion parameter, to determine the initial predicted image feature.

13. The method according to claim 12, wherein the first reference image is adjacent to the current image, and the first reference image is a reconstructed image of an image preceding to the current image by one frame.

14. The method according to claim 12, wherein the performing the motion compensation according to the first reference image feature and the reconstructed motion parameter, to determine the initial predicted image feature comprises:
performing the motion compensation on the first reference image feature and the reconstructed motion parameter by using a predicted feature generation module, to determine the initial predicted image feature.

15. The method according to claim 14, wherein the predicted feature generation module comprises a fourth convolutional module, a second concatenation module, a fifth convolutional module, and a third addition module; and
the performing the motion compensation on the first reference image feature and the reconstructed motion parameter by using the predicted feature generation module, to determine the initial predicted image feature comprises:
performing a deformable convolution operation on the reconstructed motion parameter and the first reference image feature by using the fourth convolutional module, to obtain a third intermediate feature;
performing a concatenation operation on the third intermediate feature and the first reference image feature by using the second concatenation module, to obtain a fourth intermediate feature;
performing a convolution operation on the fourth intermediate feature by using the fifth convolutional module, to obtain a fifth intermediate feature; and
performing an addition operation on the third intermediate feature and the fifth intermediate feature by using the third addition module, to obtain the initial predicted image feature.

16. The method according to claim 15, wherein
the fourth convolutional module comprises a second deformable convolutional layer;
the second concatenation module comprises a second concatenation layer; and
the fifth convolutional module comprises a fifth convolutional layer.

17. The method according to claim 1, wherein the method further comprises:
decoding the bitstream, to determine a reconstructed residual feature of the current image;
determining a reconstructed image feature based on the reconstructed residual feature and the target predicted image feature; and
performing feature enhancement and reconstruction processing on the reconstructed image feature, to determine the reconstructed image of the current image.

18. The method according to claim 17, wherein the determining the reconstructed image feature based on the reconstructed residual feature and the target predicted image feature comprises:
performing an addition operation on the reconstructed residual feature and the target predicted image feature by using a fourth addition module, to obtain the reconstructed image feature.

19. An encoding method, applied to an encoder, wherein the method comprises:
determining a reconstructed motion parameter of a current image;
determining an initial predicted image feature of the current image based on the reconstructed motion parameter; and
performing enhancement processing on the initial predicted image feature according to at least one reference image, to determine a target predicted image feature of the current image, wherein the target predicted image feature is used to determine a residual image feature of the current image.

20. A non-transitory computer-readable storage medium, having a computer program and a bitstream stored thereon, wherein the computer program, when executed by a processor, enables the processor to perform the encoding method of claim 19 to generate the bitstream.
